(19) United States
(12) Patent Application Publication
(10) Pub. No.: US 2023/0419458 A1
(43) Pub. Date: Dec. 28, 2023

(54) IMAGE DATA PROCESSING DEVICE, IMAGE DATA PROCESSING METHOD, IMAGE DATA PROCESSING PROGRAM, AND IMAGING SYSTEM

(71) Applicant: FUJIFILM Corporation, Tokyo (JP)

(72) Inventors: Yuya HIRAKAWA, Saitama (JP); Kazuyoshi OKADA, Saitama (JP); Atsushi KAWANAGO, Saitama (JP); Yasunobu KISHINE, Saitama (JP)

(73) Assignee: FUJIFILM Corporation, Tokyo (JP)

(21) Appl. No.: 18/465,989

(22) Filed: Sep. 13, 2023

Related U.S. Application Data
(63) Continuation of application No. PCT/JP2022/010196, filed on Mar. 9, 2022.

(30) Foreign Application Priority Data
Mar. 19, 2021 (JP) 2021-046580

(51) Int. Cl. G06T 5/00; G06V 10/75; G02B 5/30

(52) U.S. Cl. CPC G06T 5/005; G06V 10/751; G02B 5/3025

(57) ABSTRACT

An image data processing device processes image data captured by an imaging device that includes an optical system which spectrally separates incident light and polarizes light with the spectrally separated wavelengths, and emits the polarized light in a specific direction and an imaging element including a plurality of pixel sets each of which includes different types of polarizers. The image data processing device performs processes of: acquiring the image data; detecting a pixel whose pixel value is out of a predetermined range as an abnormal pixel from the acquired image data; correcting a pixel value of the abnormal pixel on the basis of pixel values of peripheral pixels in a case in which the abnormal pixel is detected; and generating images of the spectrally separated wavelengths from the image data in which the pixel value of the abnormal pixel has been corrected when the abnormal pixel is detected.

### CROSS-REFERENCE TO RELATED APPLICATIONS

The present application is a Continuation of PCT International Application No. PCT/JP2022/010196 filed on Mar. 9, 2022 claiming priority under 35 U.S.C § 119(a) to Japanese Patent Application No. 2021-046580 filed on Mar. 19, 2021. Each of the above applications is hereby expressly incorporated by reference, in its entirety, into the present application.

### BACKGROUND OF THE INVENTION

### 1. Field of the Invention

The present invention relates to an image data processing device, an image data processing method, an image data processing program, and an imaging system, and more particularly, relates to an image data processing device, an image data processing method, an image data processing program, and an imaging system that generate a multispectral image.

### 2. Description of the Related Art

WO2017/130581A discloses a technique that uses an imaging lens which comprises a plurality of optical systems having different imaging characteristics and an imaging element in which each pixel has directivity with respect to an incident angle of light to capture images corresponding to each optical system of the imaging lens at once. In WO2017/130581A, a predetermined interference removal process is performed on image data output from the imaging element to generate the images corresponding to each optical system. Further, in WO2017/130581A, the content of the interference removal process is changed depending on whether a saturated pixel is present or absent.

WO2018/042815A discloses a technique that processes image data captured by a so-called polarization imaging element to detect a defective pixel.

### SUMMARY OF THE INVENTION

One embodiment according to the technology of the present disclosure provides an image data processing device, an image data processing method, an image data processing program, and an imaging system that can generate a high-quality multispectral image.

(1) There is provided an image data processing device that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers. The image data processing device comprises a processor. The processor performs a process of acquiring the image data, a process of detecting a pixel whose pixel value is out of a predetermined range as an abnormal pixel from the acquired image data, a process of correcting a pixel value of the abnormal pixel on the basis of pixel values of peripheral pixels in a case in which the abnormal pixel is detected, and a process of generating images of the spectrally separated wavelengths from the image data in which the pixel value of the abnormal pixel has been corrected in a case in which the abnormal pixel is detected.

(2) In the image data processing device according to (1), the processor may perform a process of correcting the pixel value of the abnormal pixel on the basis of the pixel values of the peripheral pixels in a case in which the pixel value is out of the predetermined range due to saturation.

(3) In the image data processing device according to (1), the processor may perform a process of generating the images of the spectrally separated wavelengths from the image data excluding the abnormal pixel, without correcting the pixel value of the abnormal pixel, in a case in which the pixel value is out of the predetermined range due to a failure.

(4) In the image data processing device according to any one of (1) to (3), the process of detecting the abnormal pixel may include a process of detecting a pixel set including the abnormal pixel and a process of specifying the abnormal pixel from the detected pixel set.

(5) In the image data processing device according to (4), in the process of detecting the pixel set including the abnormal pixel, the pixel set including the abnormal pixel is detected on the basis of pixel values of pixels constituting the pixel set.

(6) In the image data processing device according to (5), in the process of detecting the pixel set including the abnormal pixel, a sum of the pixel values of the pixels constituting the pixel set or a sum of values obtained by multiplying the pixel values of the pixels constituting the pixel set by a specific coefficient is calculated, and a pixel set in which the calculated sum is equal to or greater than a first threshold value may be detected as the pixel set including the abnormal pixel.

(7) In the image data processing device according to (5) or (6), in the process of specifying the abnormal pixel, a pixel whose pixel value is equal to or less than a second threshold value and/or a pixel whose pixel value is a saturation value may be extracted from the pixel set including the abnormal pixel, and the abnormal pixel may be specified.

(8) In the image data processing device according to (5) or (6), in the process of specifying the abnormal pixel, the abnormal pixel may be specified on the basis of pixel values of pixels around the pixel set including the abnormal pixel.

(9) In the image data processing device according to (8), the process of specifying the abnormal pixel may include a process of detecting the pixel set including the abnormal pixel from pixel sets around the pixel set including the abnormal pixel, and a process of specifying the abnormal pixel from the pixel set including the abnormal pixel on the basis of a detection result of the pixel set including the abnormal pixel.

(10) In the image data processing device according to (9), a range in which the pixel set including the abnormal pixel is detected may be switched according to a resolution of the optical system.

(11) In the image data processing device according to (8), the process of specifying the abnormal pixel may include a process of estimating a pixel value of a pixel from the pixel values of the peripheral pixels and a process of specifying a pixel in which a difference from the estimated pixel value is equal to or greater than a third threshold value as the abnormal pixel.

(12) In the image data processing device according to (11), in the process of estimating the pixel value of the pixel from the pixel values of the peripheral pixels, the pixel value may be estimated from pixel values of peripheral pixels including polarizers of the same type.

(13) There is provided an image data processing method that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers. The image data processing method comprises: a process of acquiring the image data; a process of detecting a pixel whose pixel value is out of a predetermined range as an abnormal pixel from the acquired image data; a process of correcting a pixel value of the abnormal pixel on the basis of pixel values of peripheral pixels in a case in which the abnormal pixel is detected; and a process of generating images of the spectrally separated wavelengths from the image data in which the pixel value of the abnormal pixel has been corrected in a case in which the abnormal pixel is detected.

(14) There is provided an image data processing program that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers. The image data processing program causes a computer to implement: a function of acquiring the image data; a function of detecting a pixel whose pixel value is out of a predetermined range as an abnormal pixel from the acquired image data; a function of correcting a pixel value of the abnormal pixel on the basis of pixel values of peripheral pixels in a case in which the abnormal pixel is detected; and a function of generating images of the spectrally separated wavelengths from the image data in which the pixel value of the abnormal pixel has been corrected in a case in which the abnormal pixel is detected.

(15) There is provided an imaging system comprising: an imaging device that includes an optical system which spectrally separates incident light into a plurality of wavelengths, polarizes light with the spectrally separated wavelengths in a specific direction, and emits the polarized light and an imaging element including a plurality of pixel sets each of which includes different types of polarizers; and the image data processing device according to any one of (1) to (12) that processes image data captured by the imaging device.

### BRIEF DESCRIPTION OF THE DRAWINGS

FIG. 1 is a diagram illustrating a schematic configuration of a multispectral camera system to which the invention is applied.

FIG. 2 is a development view illustrating a schematic configuration of a filter unit.

FIG. 3 is a diagram illustrating an example of disposition of pixels and polarizers in an imaging element.

FIG. 4 is a diagram illustrating an example of a hardware configuration of an image data processing device.

FIG. 5 is a block diagram illustrating functions implemented by the image data processing device.

FIG. 6 is a flowchart illustrating a procedure of an abnormal pixel detection process.

FIG. 7 is a flowchart illustrating a procedure of image data processing.

FIG. 8 is a flowchart illustrating a procedure of a process of detecting and correcting an abnormal pixel.

FIG. 9 is a diagram illustrating an outline of a process in a case in which an interference removal process is performed by a method according to the related art.

FIG. 10 is a diagram illustrating an outline of a process in a case in which the interference removal process is performed by a method according to a first embodiment.

FIG. 11 is a block diagram illustrating functions implemented by the image data processing device.

FIG. 12 is a diagram illustrating an outline of a process in a case in which the interference removal process is performed by a second method.

FIG. 13 is a flowchart illustrating a procedure of image data processing by the image data processing device.

FIG. 14 is a conceptual diagram illustrating a method for specifying the abnormal pixel using peripheral pixel sets.

FIG. 15 is a diagram illustrating eight peripheral pixel sets.

FIG. 16 is a conceptual diagram in a case in which the abnormal pixel is specified by expanding a range of a pixel set to be referred to.

FIG. 17 is a diagram illustrating eight peripheral pixel sets.

FIG. 18 is a diagram further illustrating 16 peripheral pixel sets.

### DESCRIPTION OF THE PREFERRED EMBODIMENTS

Hereinafter, preferred embodiments of the invention will be described in detail with reference to the accompanying drawings.

### First Embodiment

[Multispectral Camera System]

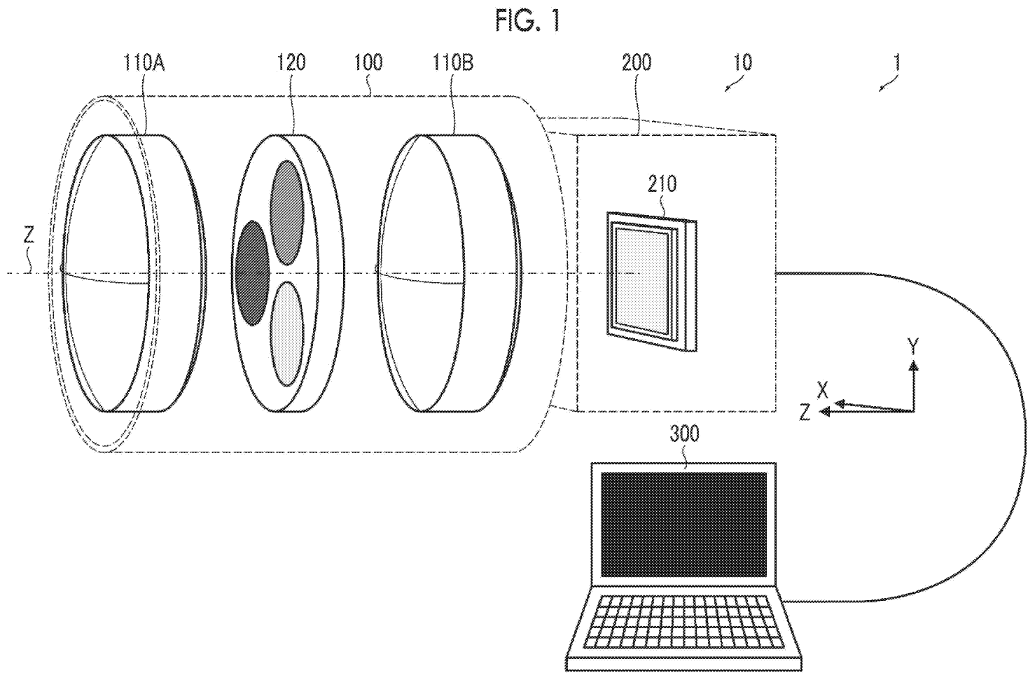

FIG. 1 is a diagram illustrating a schematic configuration of a multispectral camera system to which the invention is applied.

The multispectral camera system is a system that simultaneously captures images spectrally separated into a plurality of wavelengths. The captured image is referred to as a multispectral image.

A multispectral camera system 1 illustrated in FIG. 1 is a so-called polarization-type multispectral camera system, and FIG. 1 illustrates an example of a case in which the images spectrally separated into three wavelengths are captured. The polarization-type multispectral camera system is a multispectral camera system using polarization.

As illustrated in FIG. 1, the multispectral camera system 1 according to this embodiment is mainly composed of a multispectral camera 10 and an image data processing device 300. The multispectral camera system 1 is an example of an imaging system.

[Multispectral Camera]

The multispectral camera 10 according to this embodiment is mainly composed of a lens device 100 and a camera body 200. The multispectral camera 10 is an example of an imaging device.

[Lens Device]

The lens device 100 spectrally separates incident light into a plurality of wavelengths, polarizes light with the spectrally separated wavelengths in a specific direction, and emits the polarized light. In this embodiment, the incident light is spectrally separated into three wavelengths. The lens device 100 is an example of an optical system.

As illustrated in FIG. 1, the lens device 100 comprises a plurality of lens groups 110A and 110B and a filter unit 120.

Each of the lens groups 110A and 110B is composed of at least one lens. In FIG. 1, for convenience, only two lens groups 110A and 110B are illustrated. Hereinafter, as necessary, the lens group 110A disposed on the front side of the filter unit 120 is referred to as a first lens group, and the lens group 110B disposed on the rear side of the filter unit 120 is referred to as a second lens group to distinguish the two lens groups 110A and 110B. In addition, the “front side” means an “object side”, and the “rear side” means an “image side”.

The filter unit 120 is disposed in an optical path. Specifically, the filter unit 120 is disposed at a pupil position or in the vicinity of the pupil position in the lens device 100.

The vicinity of the pupil position means a region that satisfies the following equation.

|d|<y/(2 tan θ)

Here, θ is the maximum chief ray angle at the pupil position (a chief ray angle is an angle formed with respect to an optical axis), φ is a pupil diameter, and |d| is a distance from the pupil position.

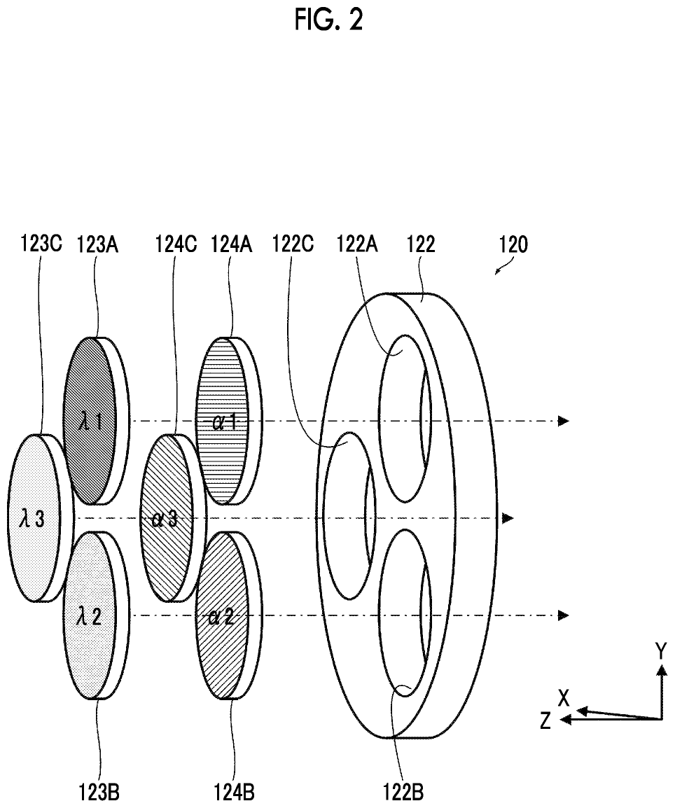

FIG. 2 is a development view illustrating a schematic configuration of the filter unit.

The filter unit 120 is composed of a filter frame 122 comprising a plurality of window portions (opening portions) and a plurality of filters (optical elements) that are mounted on each of the window portions of the filter frame 122.

As illustrated in FIG. 2, the filter frame 122 according to this embodiment has a disk shape and includes three window portions 122A, 122B, and 122C. The three window portions 122A, 122B, and 122C are configured as circular openings and are disposed at equal intervals along a circumferential direction. Hereinafter, as necessary, the window portion represented by reference numeral 122A is referred to as a first window portion, the window portion represented by reference numeral 122B is referred to as a second window portion, and the window portion represented by reference numeral 122C is referred to as a third window portion to distinguish the window portions 122A, 122B, and 122C.

Two filters are mounted on each of the three window portions 122A, 122B, and 122C. The two filters are composed of a band-pass filter (BPF) 123A, 123B, or 123C and a polarized light filter (PLF) 124A, 124B, or 124C.

The band-pass filters 123A, 123B, and 123C that transmit light in different wavelength ranges are mounted on the three window portions 122A, 122B, and 122C, respectively. The transmission wavelength ranges of the band-pass filters 123A, 123B, and 123C mounted on the three window portions 122A, 122B, and 122C are the wavelength ranges of three images to be captured. That is, the transmission wavelength ranges are the wavelength ranges of the multispectral images to be captured.

The band-pass filter 123A that transmits light in a first wavelength range λ1 is mounted on the first window portion 122A. Hereinafter, as necessary, the band-pass filter 123A mounted on the first window portion 122A is referred to as a first band-pass filter 123A to be distinguished from the other band-pass filters.

The band-pass filter 123B that transmits light in a second wavelength range λ2 is mounted on the second window portion 122B. Hereinafter, as necessary, the band-pass filter 123B mounted on the second window portion 122B is referred to as a second band-pass filter 123B to be distinguished the other band-pass filters.

The band-pass filter 123C that transmits light in a third wavelength range λ3 is mounted on the third window portion 122C. Hereinafter, as necessary, the band-pass filter 123C mounted on the third window portion 122C is referred to as a third band-pass filter 123C to be distinguished from the other band-pass filters.

From the viewpoint of a high degree of freedom of spectral transmission characteristics, it is preferable to use the band-pass filters 123A, 123B, and 123C of a reflective type.

The polarized light filters 124A, 124B, and 124C having different angles of transmission axes (orientations of transmission axes) are mounted on the three window portions 122A, 122B, and 122C, respectively.

The polarized light filter 124A having a transmission axis set to a first angle α1 (first direction) is mounted on the first window portion 122A. For example, in the lens device 100 according to this embodiment, the polarized light filter 124A having a transmission axis set to 0° is mounted. Hereinafter, as necessary, the polarized light filter 124A mounted on the first window portion 122A is referred to as a first polarized light filter 124A to be distinguished from the other polarized light filters.

The polarized light filter 124B having a transmission axis set to a second angle α2 (second direction) is mounted on the second window portion 122B. For example, in the lens device 100 according to this embodiment, the polarized light filter 124B having a transmission axis set to 600 is mounted. Hereinafter, as necessary, the polarized light filter 124B mounted on the second window portion 122B is referred to as a second polarized light filter 124B to be distinguished from the other polarized light filters.

The polarized light filter 124C having a transmission axis set to a third angle α3 (third direction) is mounted on the third window portion 122C. For example, in the lens device 100 according to this embodiment, the polarized light filter 124A having a transmission axis set to 1200 is mounted. Hereinafter, as necessary, the polarized light filter 124C mounted on the third window portion 122C is referred to as a third polarized light filter 124C to be distinguished from the other polarized light filters.

In addition, it is assumed that the angle of the transmission axis is 0° in a state in which the transmission axis is parallel to the X-axis and a counterclockwise direction as viewed from the object side (front side) is a plus (+) direction. Therefore, a transmission axis of 60° is a state in which the transmission axis is inclined with respect to the X-axis by 60° in the counterclockwise direction. Further, a transmission axis of 120° is a state in which the transmission axis is inclined with respect to the X-axis by 120° in the counterclockwise direction.

The X-axis is an axis that is set in a plane orthogonal to the optical axis Z. In the plane orthogonal to the optical axis Z, an axis orthogonal to the X-axis is the Y-axis. In the imaging element provided in the camera body 200, the upper and lower sides of a light receiving surface are disposed parallel to the X-axis, which will be described below. Furthermore, the left and right sides are disposed parallel to the Y-axis.

In addition, it is preferable to use the polarized light filters 124A, 124B, and 124C of an absorption type from the viewpoint of suppressing a ghost.

With the above configuration, the light incident on the lens device 100 is spectrally separated into three wavelengths in the process of passing through the filter unit 120, is polarized into light in a specific oscillation direction for each wavelength, and is then emitted. Specifically, the incident light is divided into light in the first wavelength range λ1 polarized in the first direction, light in the second wavelength range λ2 polarized in the second direction, and light in the third wavelength range λ3 polarized in the third direction and then emitted.

[Camera Body]

As illustrated in FIG. 1, the camera body 200 has an imaging element 210. The imaging element 210 is disposed on the optical axis of the lens device 100 and receives the light transmitted through the lens device 100. The imaging element 210 is configured as a so-called polarization imaging element. The polarization imaging element is an imaging element provided with polarizers, and the polarizer is provided for each pixel. The polarizer is provided, for example, between a microlens and a photodiode. In addition, since this type of polarization imaging element is known, the detailed description thereof will be omitted (see, for example, WO2020/071253A).

The type (the angle of the transmission axis) of the polarizer provided in the imaging element 210 is selected according to the number of wavelengths to be imaged. In a case in which the images spectrally separated into three wavelengths are captured, a polarization imaging element comprising polarizers oriented in at least three directions is used. In this embodiment, a polarization imaging element comprising polarizers oriented in four directions is used.

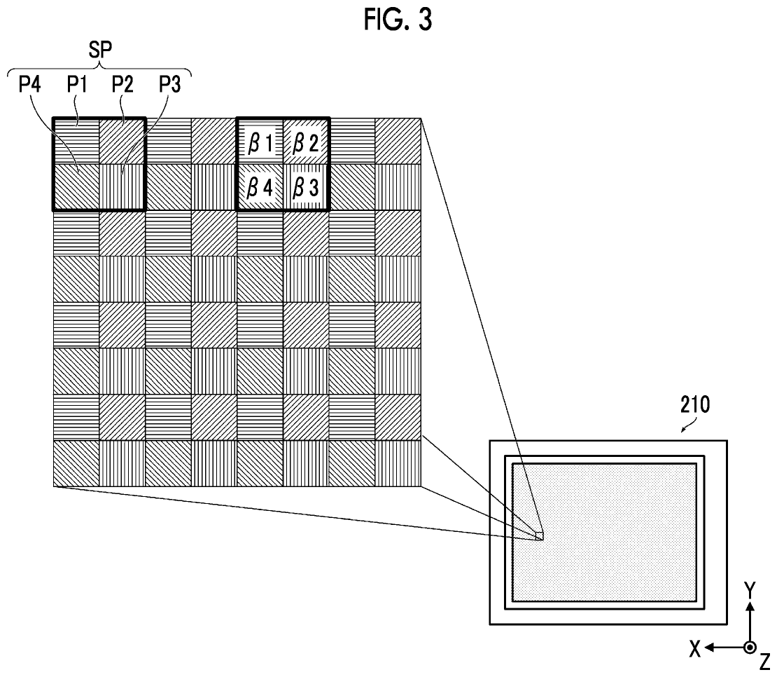

FIG. 3 is a diagram illustrating an example of the disposition of pixels and the polarizers in the imaging element.

As illustrated in FIG. 3, four polarizers having different angles of transmission axes are regularly disposed for the pixels which are arranged in a matrix. It is assumed that a polarizer of which the angle of the transmission axis is 31 is a first polarizer, a polarizer of which the angle of the transmission axis β2 is a second polarizer, a polarizer of which the angle of the transmission axis β3 is a third polarizer, a polarizer of which the angle of the transmission axis is β4 is a fourth polarizer. For example, in this embodiment, the angle β1 of the transmission axis of the first polarizer is set to 0°, the angle β2 of the transmission axis of the second polarizer is set to 45°, the angle β3 of the transmission axis of the third polarizer is set to 90°, and the angle β4 of the transmission axis of the fourth polarizer is set to 135°.

It is assumed that a pixel P1 comprising the first polarizer is a first pixel, a pixel P2 comprising the second polarizer is a second pixel, a pixel P3 comprising the third polarizer is a third pixel, and a pixel P4 comprising the fourth polarizer is a fourth pixel. 2×2 pixels consisting of the first pixel P1, the second pixel P2, the third pixel P3, and the fourth pixel P4 are defined as one pixel set SP, and the pixel sets SP are repeatedly disposed along the X-axis and the Y-axis.

The imaging element provided with the polarizers oriented in four directions can capture polarization images in four directions with one shot.

The imaging element 210 is, for example, a complementary metal oxide semiconductor (CMOS) type comprising a driving unit, an analog-to-digital converter (ADC), a signal processing unit, and the like. In this case, the imaging element 210 is driven by the built-in driving unit to operate. Further, a signal of each pixel is converted into a digital signal by the built-in ADC and is then output. Furthermore, the built-in signal processing unit performs, for example, a correlated double sampling process, gain processing, and a correction process on the signal of each pixel, and the processed signal is output. The signal processing may be performed after the signal is converted into a digital signal or may be performed before the signal is converted into a digital signal.

An output Vout (signal value of each pixel) of the imaging element 210 is, for example, as follows.

Vout=(Vin −Vth)×Gain

Here, Vin is a voltage generated by the incidence of light, Vth is a threshold voltage, and Gain is a gain.

In the case of 8 bits, the range of Vout is 0 to 255. Therefore, in a case in which the intensity of the incident light is too high, a saturated pixel occurs. For example, in the case of 8 bits, even though the output voltage is equal to or greater than 255, all of the output voltage is represented by 255. In addition, for a failed pixel, the output of only the failed pixel has a value of 0 or a value close to 0.

The camera body 200 comprises, for example, an output unit (not illustrated) that outputs data of the image captured by the imaging element 210 and a camera control unit (not illustrated) that controls the overall operation of the camera body 200 in addition to the imaging element 210. The camera control unit is configured as, for example, a micro processing unit (MPU) comprising a processor and a memory. The micro processing unit executes a predetermined control program to function as the camera control unit.

In addition, the data of the image output from the camera body 200 is so-called RAW image data. That is, the data is unprocessed image data. The image data processing device 300 processes the RAW image data to generate the images spectrally separated into a plurality of wavelengths.

[Image Data Processing Device]

The image data processing device 300 processes the image data (RAW image data) output from the camera body 200 of the multispectral camera 10 to generate the images spectrally separated into a plurality of wavelengths. Specifically, the images of the wavelengths which correspond to the transmission wavelength ranges λ1, λ2, and λ3 of the band-pass filters 123A, 123B, and 123C mounted on the window portions 122A, 122B, and 122C of the filter unit 120 provided in the lens device 100 are generated.

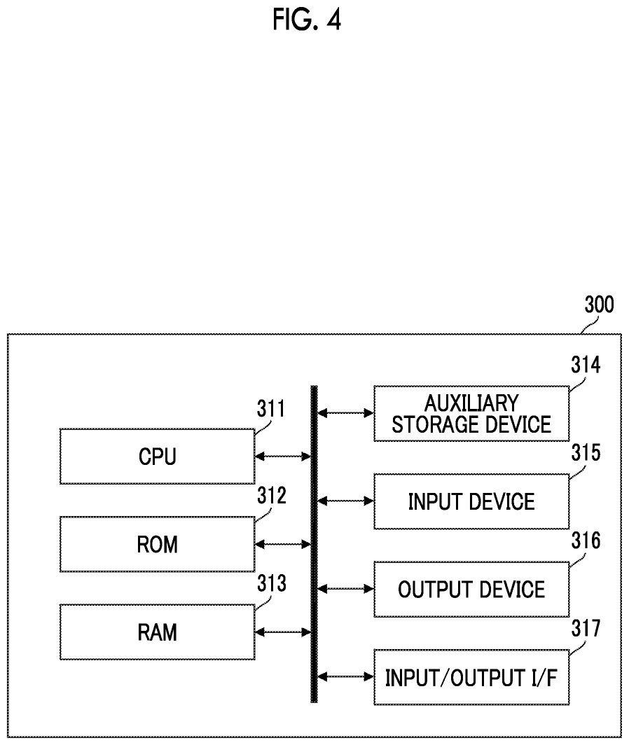

FIG. 4 is a block diagram illustrating an example of a hardware configuration of the image data processing device.

As illustrated in FIG. 4, the image data processing device 300 comprises, for example, a central processing unit (CPU) 311 and a read only memory (ROM) 312, a random access memory (RAM) 313, an auxiliary storage device 314, an input device 315, an output device 316, and an input/output interface (I/F) 317. The image data processing device 300 is configured as, for example, a general-purpose computer such as a personal computer.

In the image data processing device 300, the CPU 311, which is a processor, executes a predetermined program (image data processing program) to function as the image data processing device. The program executed by the CPU 311 is stored in the ROM 312 or the auxiliary storage device 314.

The auxiliary storage device 314 constitutes a storage unit of the image data processing device 300. The auxiliary storage device 314 is composed of, for example, a hard disk drive (HDD) and a solid state drive (SSD).

The input device 315 constitutes an operation unit of the image data processing device 300. The input device 315 is composed of, for example, a keyboard, a mouse, and a touch panel.

The output device 316 constitutes a display unit of the image data processing device 300. The output device 316 is configured as, for example, a display such as a liquid crystal display or an organic light emitting diode display.

The input/output interface 317 constitutes a connection unit of the image data processing device 300. The image data processing device 300 is connected to the camera body 200 of the multispectral camera 10 through the input/output interface 317.

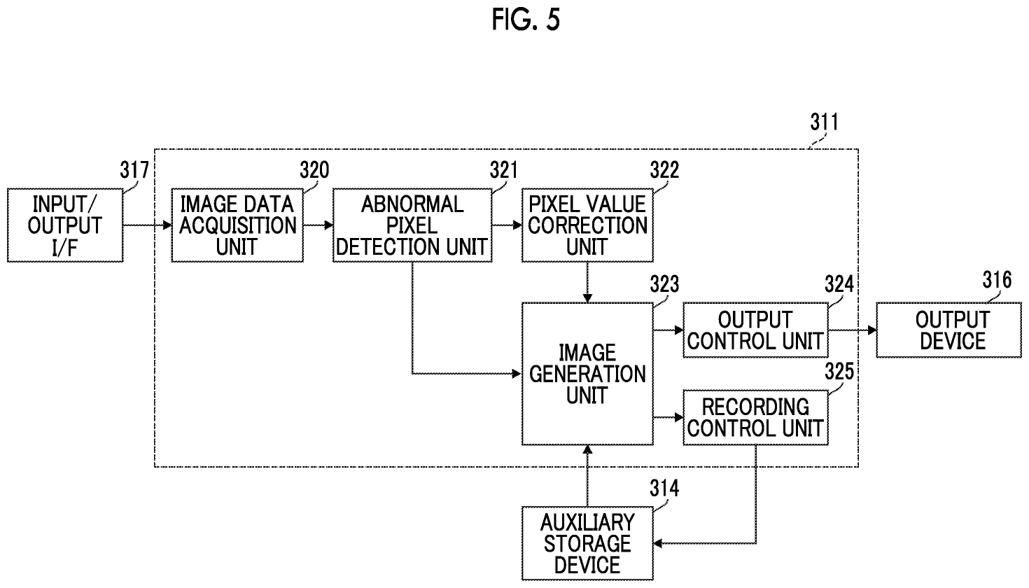

FIG. 5 is a block diagram illustrating functions implemented by the image data processing device.

As illustrated in FIG. 5, the image data processing device 300 implements the functions of an image data acquisition unit 320, an abnormal pixel detection unit 321, a pixel value correction unit 322, an image generation unit 323, an output control unit 324, and a recording control unit 325. The CPU 311 executes a predetermined program (image data processing program) to implement these functions.

The image data acquisition unit 320 acquires the image data obtained by imaging from the multispectral camera 10. As described above, the image data acquired from the multispectral camera 10 is RAW image data. The image data is acquired through the input/output interface 317.

The abnormal pixel detection unit 321 performs a process of analyzing the acquired image data to detect an abnormal pixel. Here, the abnormal pixel is a pixel having a pixel value that is out of a predetermined range and is a pixel having a so-called improper brightness value. The abnormal pixel includes a failed pixel and a saturated pixel. The failed pixel is a pixel whose pixel value is out of a predetermined range due to a failure. The saturated pixel is a pixel whose pixel value is out of a predetermined range due to saturation. The failed pixel has a pixel value of 0 or a pixel value close to 0. On the other hand, the pixel value of the saturated pixel is a saturation value. For example, in the case of 8 bits, the pixel value is 255.

In a case in which the captured image data includes the abnormal pixel, it is impossible for the image generation unit 323 in the subsequent stage to generate an appropriate image in the generation of the image of each wavelength. Therefore, the image data processing device 300 according to this embodiment detects the abnormal pixel in the captured image data, corrects the abnormal pixel, and generates the images of each wavelength.

The detection of the abnormal pixel is performed in units of the pixel sets SP.

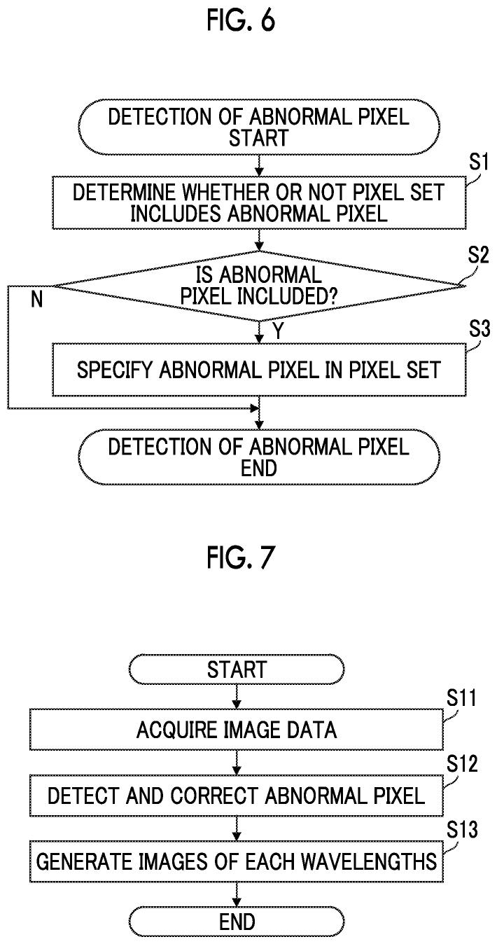

FIG. 6 is a flowchart illustrating a procedure of an abnormal pixel detection process.

First, a process of determining whether or not a target pixel set SP includes the abnormal pixel is performed (Step S1). Then, it is determined whether or not the target pixel set SP includes the abnormal pixel on the basis of the result of the determination process (Step S2). In a case in which it is determined that the target pixel set SP does not include the abnormal pixel, the abnormal pixel detection process for the pixel set is ended. On the other hand, in a case in which it is determined that the target pixel set SP includes the abnormal pixel, a process of specifying the abnormal pixel in the target pixel set SP is performed (Step S3).

The process of determining whether or not the target pixel set SP includes the abnormal pixel is performed on the basis of signal values (pixel values) of four pixels P1, P2, P3, and P4 constituting the pixel set SP.

As described above, the imaging element 210 used in the multispectral camera 10 according to this embodiment is a polarization imaging element. In the polarization imaging element, the outputs of the pixels in each pixel set have a certain relationship. That is, a certain relationship is established between the output signals on the basis of the setting of the angle of the transmission axis of the polarizer provided in each pixel. For example, in a case in which one pixel set SP is composed of the four pixels P1 to P4 and the four pixels P1 to P4 have polarizers of which the angles of the transmission axes are 0°, 45°, 90°, and 135°, respectively, as in the imaging element 210 according to this embodiment, the relationship of the following Equation (1) is established. However, it is assumed that the same amount of light is incident on the pixels P1 to P4.

x1+x3=x2+x4 (1)

Here, x1 is the pixel value of the first pixel P1, that is, the pixel value of the pixel in which the angle of the transmission axis of the polarizer is 0°. In addition, x2 is the pixel value of the second pixel P2, that is, the pixel value of the pixel in which the angle of the transmission axis of the polarizer is 45°. Further, x3 is the pixel value of the third pixel P3, that is, the pixel value of the pixel in which the angle of the transmission axis of the polarizer is 90°. Furthermore, x4 is the pixel value of the fourth pixel P4, that is, the pixel value of the pixel in which the angle of the transmission axis of the polarizer is 135°.

That is, in the imaging element provided with the polarizers of which the angles of the transmission axes are 0°, 45°, 90°, and 135°, the sums of the pixel values of the pixels comprising the polarizers which are orthogonal to each other are the same in each pixel set.

In a case in which the pixel set SP includes the abnormal pixel, the relationship of the above-described Equation (1) breaks down. In the image data processing device 300 according to this embodiment, it is determined whether or not the target pixel set SP includes the abnormal pixel using the relationship represented by the above-described Equation (1). Specifically, E is calculated by the following Equation (2). In a case in which E is equal to or greater than a threshold value Th1, it is determined that the target pixel set SP includes the abnormal pixel. E is referred to as an intensity value. The threshold value Th1 is an example of a first threshold value.

E=(x1+x3)−(x2+x4) (2)

In a case in which the target pixel set SP includes the abnormal pixel, the process of specifying the abnormal pixel in the pixel set SP is performed as follows. That is, a pixel whose pixel value is equal to or less than a threshold value Th2 and a pixel whose pixel value is the saturation value are extracted from the target pixel set SP, and the extracted pixels are specified as the abnormal pixels.

Here, a process of extracting the pixel whose pixel value is equal to or less than the threshold value Th2 is a process of extracting the failed pixel. The output of the failed pixel has a value of 0 or a value close to 0. Therefore, the pixel whose pixel value is 0 or is close to 0 is extracted, and the failed pixel is specified. Therefore, the threshold value Th2 is set to a value of 0 or a value close to 0. The threshold value Th2 is an example of a second threshold value.

On the other hand, a process of extracting the pixel whose pixel value is the saturation value is a process of extracting the saturated pixel. Since the pixel value of the saturated pixel is the saturation value, the pixel whose pixel value is the saturation value is extracted, and the saturated pixel is specified. In a case in which the output of the imaging element 210 is 8 bits, the saturation value is 255.

The pixel value correction unit 322 performs a process of correcting the pixel value of the abnormal pixel in a case in which the abnormal pixel is detected. The pixel value correction unit 322 corrects the pixel value of the abnormal pixel on the basis of the pixel values of the pixels around the abnormal pixel. In this embodiment, the pixel value of the abnormal pixel is corrected on the basis of the pixel values of other pixels in the pixel set in which the abnormal pixel has been detected. That is, since the pixel values of the pixels in the same pixel set have the relationship represented by the above-described Equation (1), the pixel value of the abnormal pixel is estimated and corrected using the relationship represented by the above-described Equation (1).

For example, it is assumed that the pixel value x1 of the first pixel P1 is 180, the pixel value x2 of the second pixel P2 is 158.0385, the pixel value x3 of the third pixel P3 is 240, and the pixel value x4 of the fourth pixel P4 is 255. In this case, since the pixel value x4 of the fourth pixel P4 is the saturation value, the fourth pixel P4 is the abnormal pixel. The pixel value x4 of the fourth pixel P4 is calculated as x4=x1+x3−x2 from the above-described Equation (1). Therefore, in this case, the pixel value x4 of the fourth pixel P4 is corrected to 261.9615 from x4=180+240−158.0385.

The image generation unit 323 performs predetermined signal processing on the image data obtained by imaging to perform a process of generating images of a plurality of wavelengths. In a case in which the process of correcting the pixel value is performed, predetermined signal processing is performed on the corrected image data to generate images of a plurality of wavelengths. The images of a plurality of wavelengths are images of the wavelengths spectrally separated in the lens device 100 of the multispectral camera 10. Specifically, the images of a plurality of wavelengths are images of the transmission wavelength ranges of the band-pass filters 123A, 123B, and 123C mounted on the window portions 122A, 122B, and 122C of the filter unit 120. In this embodiment, an image (first image) of the first wavelength range λ1, an image (second image) of the second wavelength range λ2, and an image (third image) of the third wavelength range λ3 are generated. The image generation unit 323 performs a process (interference removal process) of removing interference on the image data acquired by the image data acquisition unit 320 in units of pixel sets to generate the images of the wavelength ranges λ1, λ2, and λ3. Hereinafter, this process will be outlined.

As described above, in the imaging element (polarization imaging element) provided with the polarizers oriented in four directions, it is possible to capture polarization images in four directions with one shot. The polarization images in the four directions include image components of the wavelength ranges λ1, λ2, and λ3 at a predetermined ratio (interference ratio). The interference ratio is determined by the angles α1, α2, and α3 of the transmission axes of the polarized light filters 124A, 124B, and 124C mounted on the window portions 122A, 122B, and 122C of the filter unit 120 and the angles of the transmission axes of the polarizers comprised in each of the pixels P1, P2, P3, and P4 of the imaging element 210. Specifically, the interference ratio is calculated by the square of the cosine (cos) of the difference between the angles α1, α2, and α3 of the transmission axes of the polarized light filters 124A, 124B, and 124C mounted on the window portions 122A, 122B, and 122C and the angles β1, β2, γ3, and β4 of the transmission axes of the polarizers comprised in each of the pixels P1, P2, P3, and P4. Therefore, for example, the ratio (interference ratio) at which light transmitted through the first window portion 122A (light transmitted through the first polarized light filter 124A) is received by the first pixel P1 is calculated by cos²(|α1−β1|).

As described above, the interference ratio is known, and the image of each wavelength can be generated using information of the known interference ratio. Specifically, the image of each wavelength is generated as follows.

It is assumed that, in the image captured by the imaging element 210, the pixel value of the first pixel P1 is x1, the pixel value of the second pixel P2 is x2, the pixel value of the third pixel P3 is x3, and the pixel value of the fourth pixel P4 is x4.

Further, it is assumed that the pixel value of the corresponding pixel of the generated first image is X1, the pixel value of the corresponding pixel of the second image is X2, and the pixel value of the corresponding pixel of the third image is X3.

Assuming that the ratio at which light in the first wavelength range λ1 is received by the first pixel P1 is b11, the ratio at which light in the second wavelength range λ2 is received by the first pixel P1 is b12, and the ratio at which light in the third wavelength range λ3 is received by the first pixel P1 is b13, the following relationship is established between X1, X2, and X3, and x1.

b11*X1+b12*X2+b13*X3=x1 (3-1)

Further, assuming that the ratio at which the light in the first wavelength range λ1 is received by the second pixel P2 is b21, the ratio at which the light in the second wavelength range λ2 is received by the second pixel P2 is b22, and the ratio at which the light in the third wavelength range λ3 is received by the second pixel P2 is b23, the following relationship is established between X1, X2, and X3, and x2.

b21*X1+b22*X2+b23*X3=x2 (3-2)

Further, assuming that the ratio at which the light in the first wavelength range λ1 is received by the third pixel P3 is b31, the ratio at which the light in the second wavelength range λ2 is received by the third pixel P3 is b32, and the ratio at which the light in the third wavelength range λ3 is received by the third pixel P3 is b33, the following relationship is established between X1, X2, and X3, and x3.

b31*X1+b32*X2+b33*X3=x3 (3-3)

Further, assuming that the ratio at which the light in the first wavelength range λ1 is received by the fourth pixel P4 is b41, the ratio at which the light in the second wavelength range λ2 is received by the fourth pixel P4 is b42, and the ratio at which the light in the third wavelength range λ3 is received by the fourth pixel P4 is b43, the following relationship is established between X1, X2, and X3, and x4.

b41*X1+b42*X2+b43*X3=x4 (3-4)

For X1, X2, and X3, the simultaneous equations of the above-described Equations (3-1) to (3-4) can be solved to acquire the pixel values X1, X2, and X3 of the corresponding pixels of the first image, the second image, and the third image.

As described above, the use of the information of the interference ratio makes it possible to generate the image of each wavelength from the image captured by the imaging element.

Here, the above-mentioned simultaneous equations can be represented by the following Equation 4 using a matrix B.

$$B = [ \begin{matrix}b 11 & b 12 & b 13 \\ b 21 & b 22 & b 24 \\ b 31 & b 32 & b 33 \\ b 41 & b 42 & b 43\end{matrix} ] \qquad ( 4 )$$

$$B \times [ \begin{matrix}X 1 \\ X 2 \\ X 3\end{matrix} ] = [ \begin{matrix}x 1 \\ x 2 \\ x 3 \\ x 4\end{matrix} ]$$

It is assumed that an inverse matrix B⁻¹ of the matrix B is a matrix A.

$${B}^{- 1} = A = [ \begin{matrix}a 11 & a 12 & a 13 & a 14 \\ a 21 & a 22 & a 23 & a 24 \\ a 31 & a 32 & a 33 & a 34\end{matrix} ]$$

X1, X2, and X3 can be calculated by multiplying both sides of the above-described Equation (4) by the matrix A. That is, X1, X2, and X3 can be calculated by the following Equation (5). The matrix A is an interference removal matrix.

$$[ \begin{matrix}X 1 \\ X 2 \\ X 3\end{matrix} ] = A \times [ \begin{matrix}x 1 \\ x 2 \\ x 3 \\ x 4\end{matrix} ] \qquad ( 5 )$$

The image data processing device 300 holds each element (all, α12, . . . ) of the interference removal matrix A as a coefficient group. Information of the coefficient group is stored in, for example, the auxiliary storage device 314. The image generation unit 323 acquires the information of the coefficient group from the auxiliary storage device 314, performs an interference removal process, and generates the images of each wavelength.

The output control unit 324 controls the output of the images (the first image, the second image, and the third image) of each wavelength generated by the image generation unit 323. In this embodiment, the output control unit 324 controls the output to a display which is the output device 316.

The recording control unit 325 controls the recording of the images of each wavelength generated by the image generation unit 323 in response to an instruction from the user. The generated images of each wavelength are recorded on the auxiliary storage device 314.

[Procedure of Image Data Processing]

FIG. 7 is a flowchart illustrating a procedure of image data processing.

First, the process of acquiring image data from the multispectral camera 10 is performed (Step S11). Then, the process of detecting the abnormal pixel from the acquired image data and correcting the abnormal pixel is performed (Step S12). Then, the process of generating the images of each wavelength is performed (Step S13).

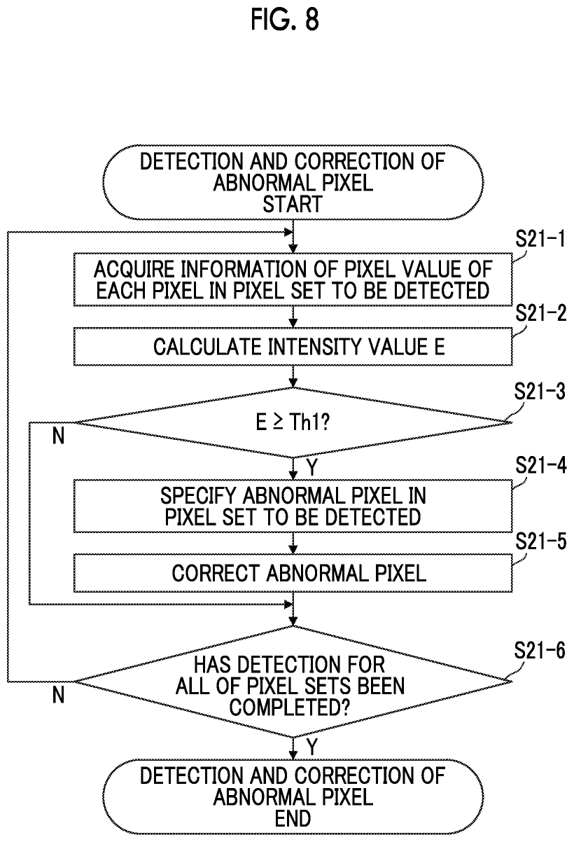

FIG. 8 is a flowchart showing a procedure of the process of detecting and correcting the abnormal pixel.

As described above, the process of detecting the abnormal pixel is performed in units of pixel sets. First, information of the pixel values x1 to x4 of the pixels P1 to P4 in the pixel set to be detected is acquired (Step S21_1). Then, the intensity value E is calculated from the acquired pixel values x1 to x4 of the pixels P1 to P4 (Step S21_2). That is, a value of E=(x1+x3)−(x2+x4) is calculated. Then, the calculated intensity value E is compared with the threshold value Th1, and it is determined whether or not the intensity value E is equal to or greater than the threshold value Th1 (Step S21_3).

Here, the case in which the intensity value E is equal to or greater than the threshold value Th1 is a case in which the target pixel set includes the abnormal pixel. On the other hand, the case in which the intensity value E is less than the threshold value Th1 is a case in which the target pixel set does not include the abnormal pixel.

In a case in which the intensity value E is equal to or greater than the threshold value Th1, the process of specifying the abnormal pixel is performed (Step S21_4). This process is performed by extracting the pixel whose pixel value is equal to or less than the threshold value Th2 and the pixel whose pixel value is the saturation value from the target pixel set.

On the other hand, in a case in which the intensity value E is less than the threshold value Th1, the process on the abnormal pixel in the target pixel set is ended. Then, it is determined whether or not the detection of the abnormal pixel for all of the pixel sets has been completed (Step S21_6). In a case in which the detection of the abnormal pixel for all of the pixel sets has not been completed, information of the pixel values of the next pixel set is acquired (Step S21_1), and the detection of the abnormal pixel is performed in the same procedure. In a case in which the detection of the abnormal pixel for all of the pixel sets has been completed, the process of detecting and correcting the abnormal pixel is ended.

In a case in which the abnormal pixel is specified in Step S21_4, the process of correcting the pixel value of the specified abnormal pixel is performed (Step S21_5). That is, a true pixel value is estimated from the pixel values of other pixels in the pixel set, and the pixel value of the abnormal pixel is corrected with the estimated pixel value. The true pixel value is estimated using the relationship of x1+x3=x2+x4. After the correction, it is determined whether or not the detection of the abnormal pixel for all of the pixel sets has been completed (Step S21_6). In a case in which the detection of the abnormal pixel for all of the pixel sets has not been completed, information of the pixel values of the next pixel set is acquired (Step S21_1), and the detection of the abnormal pixel is performed in the same procedure. In a case in which the detection of the abnormal pixel for all of the pixel sets has been completed, the process of detecting and correcting the abnormal pixel is ended.

In a case in which the correction of the abnormal pixel is performed, in the process of generating the images of each wavelength, the images of each wavelength are generated on the basis of the corrected image data.

As described above, according to the image data processing device 300 of this embodiment, in a case in which the captured image data includes the abnormal pixel, the pixel value of the abnormal pixel is corrected. Therefore, it is possible to generate a high-quality image. That is, in a case in which the interference removal process is performed in a state in which the abnormal pixel is included, there is a concern that the generated image will be corrupted. However, the image data processing device 300 according to this embodiment corrects the pixel value of the abnormal pixel and performs the interference removal process. Therefore, it is possible to generate a high-quality image.

### Examples

The comparison of the effects with a case in which the interference removal process is performed by a method according to the related art is as follows.

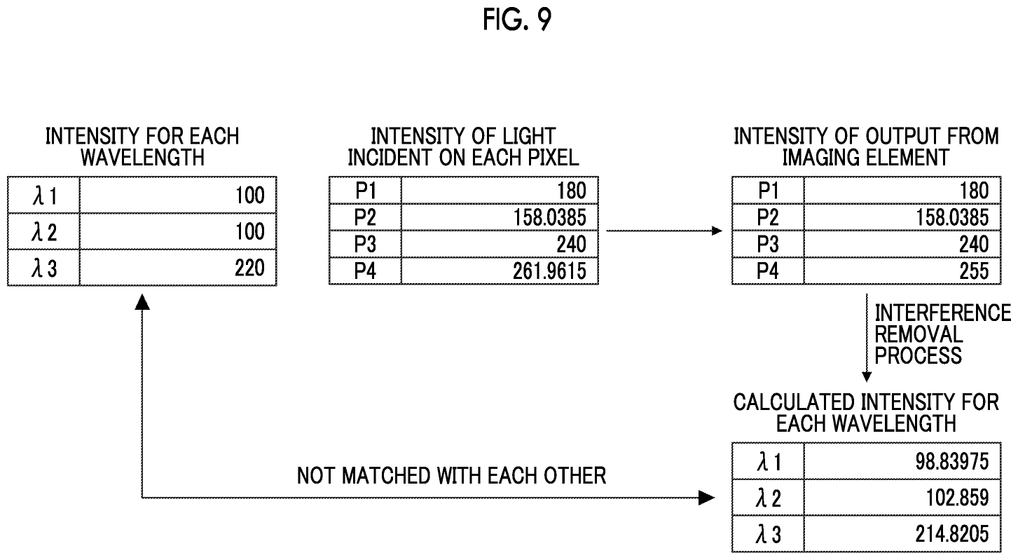

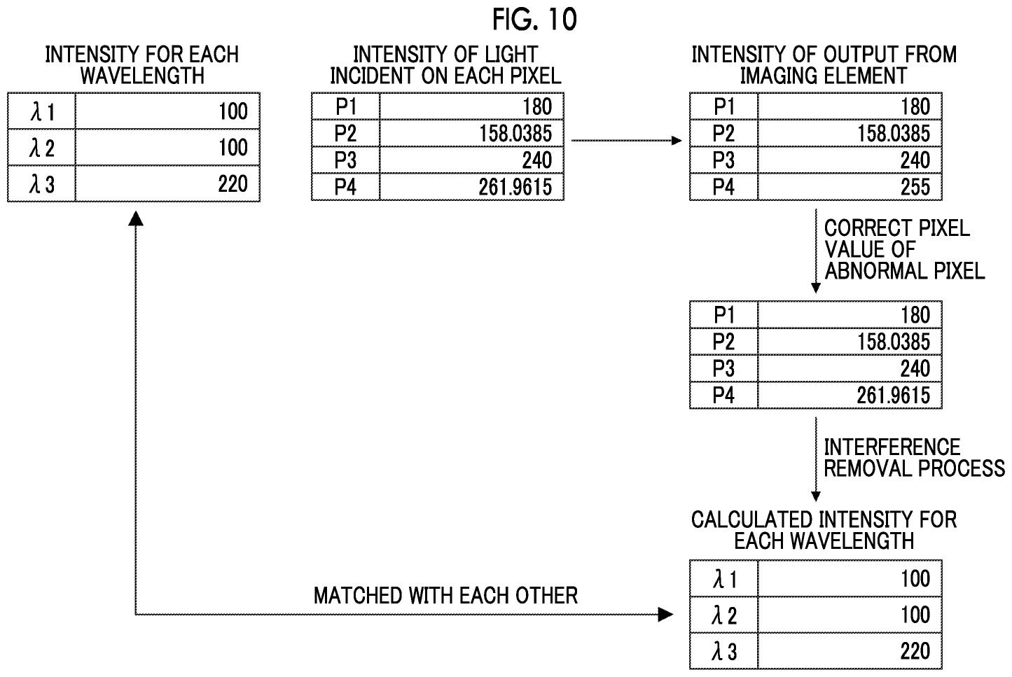

FIG. 9 is a diagram illustrating an outline of a process in a case in which the interference removal process is performed by the method according to the related art. FIG. 10 is a diagram illustrating an outline of a process in a case in which the interference removal process is performed by the method according to the above-described embodiment.

The method according to the related art is a method in which the interference removal process is performed as it is without performing any process even in a case in which the abnormal pixel is included.

FIGS. 9 and 10 illustrate an example of a case in which light with each wavelength is incident on a certain pixel set with the following intensity. That is, FIGS. 9 and 10 illustrate an example of a case in which the intensity of light in the first wavelength range λ1 is 100, the intensity of light in the second wavelength range λ2 is 100, and the intensity of light in the third wavelength range λ3 is 220.

In addition, FIGS. 9 and 10 illustrate an example of a case in which light is incident on each of the pixels P1 to P4 in the pixel set with the following intensity. That is, the intensity of light incident on the first pixel P1 is 180, the intensity of light incident on the second pixel is 158.0385, the intensity of light incident on the third pixel P3 is 240, and the intensity of light incident on the fourth pixel P4 is 261.9615.

Further, FIGS. 9 and 10 illustrate an example of a case in which the output of the imaging element is 8 bits. In this case, the signal value (pixel value) of each pixel that is actually output from the imaging element is as follows. That is, the pixel value of the first pixel P1 is 180, the pixel value of the second pixel is 158.0385, the pixel value of the third pixel P3 is 240, and the pixel value of the fourth pixel P4 is 255. That is, the pixel value of the fourth pixel P4 is output as the saturation value (255).

As illustrated in FIG. 9, in the method according to the related art, even in a case in which the abnormal pixel is included, the interference removal process is performed as it is. Therefore, the calculated intensity of each wavelength is different from the actual intensity.

On the other hand, as illustrated in FIG. 10, according to the method of the above-described embodiment, in a case in which the abnormal pixel is included, correction is performed and then the interference removal process is performed. Therefore, it is possible to calculate the correct value of the intensity of each wavelength.

### Second Embodiment

In a case in which the captured image data has redundancy, the images of each wavelength can be generated even though the abnormal pixel is excluded. For example, in a case in which the images of three wavelengths are generated, the number of pixels required to generate the images of each wavelength is three. That is, one pixel set may be composed of three pixels (pixels having polarizers oriented in three directions). Therefore, in a case in which one pixel set is composed of four pixels (pixels having polarizers oriented in four directions), there is redundancy, and the images of each wavelength can be generated even though one pixel is omitted. That is, interference can be removed. In this case, the interference removal matrix is changed to generate the images of each wavelength. That is, the interference removal matrix is changed, and the interference removal process is performed.

However, a pixel (failed pixel) which has become the abnormal pixel due to a failure outputs an abnormal signal value each time. That is, the same pixel becomes the abnormal pixel each time. In a case in which the same pixel becomes the abnormal pixel each time, the position of the abnormal pixel is known. Therefore, a method for generating the images of each wavelength from the image data excluding the abnormal pixel is preferable because the process can be simplified. That is, the interference removal matrix can be prepared in advance. Therefore, the process can be simplified because the correction process is not performed.

On the other hand, a pixel (saturated pixel) that has become the abnormal pixel due to saturation may not become abnormal by changing, for example, a scene and settings. Therefore, for the saturated pixel, the method according to the first embodiment, that is, a method for performing correction and a normal interference removal process is preferable.

In the image data processing device according to this embodiment, in a case in which the image data obtained by imaging includes the abnormal pixel, an interference removal processing method is changed according to the cause of the abnormality to generate the images of each wavelength.

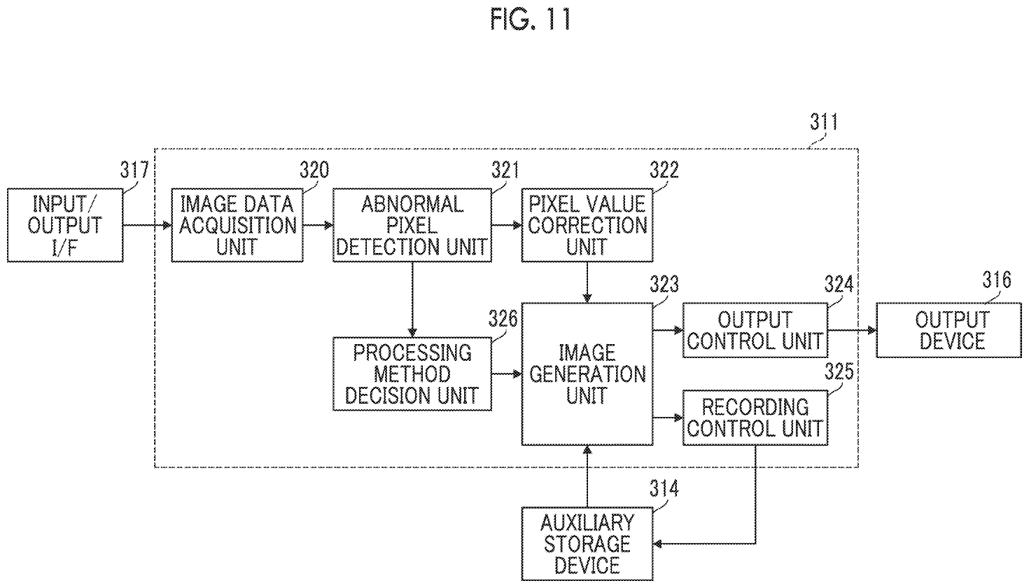

FIG. 11 is a block diagram illustrating functions implemented by the image data processing device.

As illustrated in FIG. 11, the image data processing device 300 according to this embodiment further implements a function of a processing method decision unit 326 in addition to the functions implemented by the image data processing device 300 according to the first embodiment.

The processing method decision unit 326 decides an image processing method by the image generation unit 323 on the basis of the detection result of the abnormal pixel by the abnormal pixel detection unit 321. That is, the interference removal processing method is decided according to the cause of the abnormality. Specifically, in a case in which the abnormality is caused by saturation, the interference removal process is performed by a first method. On the other hand, in a case in which the abnormality is caused by a failure, the interference removal process is performed by a second method. The first method is a method that corrects the pixel value of the abnormal pixel and generates the images of each wavelength. In this case, the normal interference removal process is performed. That is, the interference removal process is performed using a normal interference removal matrix. The second method is a method that excludes the abnormal pixel and generates the images of each wavelength. In this case, the interference removal matrix is changed, and the interference removal process is performed.

The cause of the abnormality is determined on the basis of the pixel value of the abnormal pixel. Specifically, in a case in which the pixel value is the saturation value, it is determined that the abnormality is caused by saturation. For example, in a case in which the output is 8 bits and the pixel value is 255, it is determined that the abnormality is caused by saturation. Further, in a case in which the pixel value is equal to or less than the threshold value Th2, it is determined that the abnormality is caused by a failure. The processing method is decided in units of pixel sets.

The image generation unit 323 processes the image data according to the processing method decided by the processing method decision unit 326 to generate the images of each wavelength. The process is performed in units of pixel sets.

Since the process using the first method is the same as the process according to the first embodiment, the process using the second method will be described here.

A case in which, in a certain pixel set, the first pixel P1 is determined to be abnormal due to a failure is considered. In this case, in the second method, the images of each wavelength are generated on the basis of the pixel values of the second pixel P2, the third pixel P3, and the fourth pixel P4.

It is assumed that the pixel value of the second pixel P2 is x2, the pixel value of the third pixel P3 is x3, and the pixel value of the fourth pixel P4 is x4. It is assumed that the pixel values of the corresponding pixels of the generated images of three wavelengths are X1, X2, and X3.

The ratio at which the light in the first wavelength range λ1 is received by the second pixel P2 is d21, the ratio at which the light in the second wavelength range λ2 is received by the second pixel P2 is d22, and the ratio at which the light in the third wavelength range λ3 is received by the second pixel P2 is d23, the following relationship is established between X1, X2, and X3, and x2.

d21*X1+d22*X2+d23*X3=x2 (6-1)

Further, the ratio at which the light in the first wavelength range λ1 is received by the third pixel P3 is d31, the ratio at which the light in the second wavelength range λ2 is received by the third pixel P3 is d32, and the ratio at which the light in the third wavelength range λ3 is received by the third pixel P3 is d33, the following relationship is established between X1, X2, and X3, and x3.

d31*X1+d32*X2+d33*X3=x3 (6-2)

Further, the ratio at which the light in the first wavelength range λ1 is received by the fourth pixel P4 is d41, the ratio at which the light in the second wavelength range λ2 is received by the fourth pixel P4 is d42, and the ratio at which the light in the third wavelength range λ3 is received by the fourth pixel P4 is d43, the following relationship is established between X1, X2, and X3, and x4.

d41*X1+d42*X2+d43*X3=x4 (6-3)

For X1, X2, and X3, the simultaneous equations of the above-described Equations (6-1) to (6-3) can be solved to acquire the pixel values X1, X2, and X3 of the corresponding pixels of the first image, the second image, and the third image.

Here, the above-mentioned simultaneous equations can be represented by the following Equation (7) using a matrix D.

$$D = [ \begin{matrix}d 21 & d 22 & d 24 \\ d 31 & d 32 & d 33 \\ d 41 & d 42 & d 43\end{matrix} ] \qquad ( 7 )$$

$$D \times [ \begin{matrix}X 1 \\ X 2 \\ X 3\end{matrix} ] = [ \begin{matrix}x 2 \\ x 3 \\ x 4\end{matrix} ]$$

It is assumed that an inverse matrix D⁻¹ of the matrix D is a matrix C. The matrix C is an interference removal matrix.

$${D}^{- 1} = C = [ \begin{matrix}c 11 & c 12 & c 13 \\ c 21 & c 22 & c 23 \\ c 31 & c 32 & c 33\end{matrix} ]$$

X1, X2, and X3 can be calculated by multiplying both sides of the above-described Equation (7) by the interference removal matrix C. That is, X1, X2, and X3 can be calculated by the following Equation (8).

$$[ \begin{matrix}X 1 \\ X 2 \\ X 3\end{matrix} ] = C \times [ \begin{matrix}x 2 \\ x 3 \\ x 4\end{matrix} ] \qquad ( 8 )$$

As described above, the pixel values X1, X2, and X3 of the corresponding pixels in the images of each wavelength can be calculated from the information of the pixel values of the other pixels in the pixel set.

The above is the processing method in a case in which the first pixel P1 is determined to be the abnormal pixel. In a case in which a pixel other than the first pixel is determined to be the abnormal pixel, the pixel values X1, X2, and X3 of the corresponding pixels can be calculated by the same method.

The auxiliary storage device 314 stores the information of the interference removal matrix in a case in which the first pixel P1 is excluded and the interference removal process is performed, the information of the interference removal matrix in a case in which the second pixel P2 is excluded and the interference removal process is performed, the information of the interference removal matrix in a case in which the third pixel P3 is excluded and the interference removal process is performed, and the information of the interference removal matrix in a case in which the fourth pixel P4 is excluded and the interference removal process is performed. In addition, the information of the interference removal matrix is information in which each element of the interference removal matrix is a coefficient group.

The image generation unit 323 acquires the information of the coefficient group from the auxiliary storage device 314, performs the interference removal process, and generates the images of each wavelength.

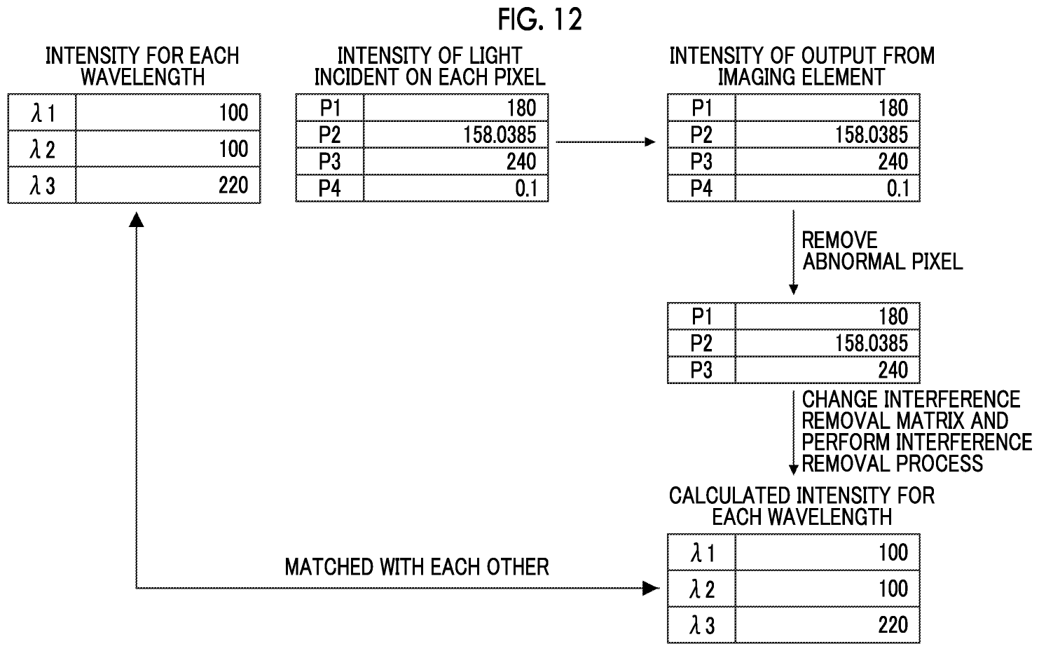

FIG. 12 is a diagram illustrating an outline of a process in a case in which the interference removal process is performed by the second method.

FIG. 12 illustrates an example of a case in which light with each wavelength is incident on a certain pixel set with the following intensity. That is, FIG. 12 illustrates an example of a case in which the intensity of light in the first wavelength range λ1 is 100, the intensity of light in the second wavelength range λ2 is 100, and the intensity of light in the third wavelength range λ3 is 220. In addition, FIG. 12 illustrates an example of a case in which light is incident on each of the pixels P1 to P4 in the pixel set with the following intensity. That is, the intensity of light incident on the first pixel P1 is 180, the intensity of light incident on the second pixel P2 is 158.0385, the intensity of light incident on the third pixel P3 is 240, and the intensity of light incident on the fourth pixel P4 is 0.1. That is, FIG. 12 illustrates an example of a case in which the fourth pixel P4 is a failed pixel.

As described above, in the second method, in a case in which the abnormal pixel is included, the interference removal process is performed with three pixels excluding the abnormal pixel. That is, the interference removal process is performed with three pixels of the first pixel P1, the second pixel P2, and the third pixel P3. This makes it possible to eliminate the influence of the abnormal pixel and to calculate the correct value of the intensity of each wavelength.

[Procedure of Image Data Processing]

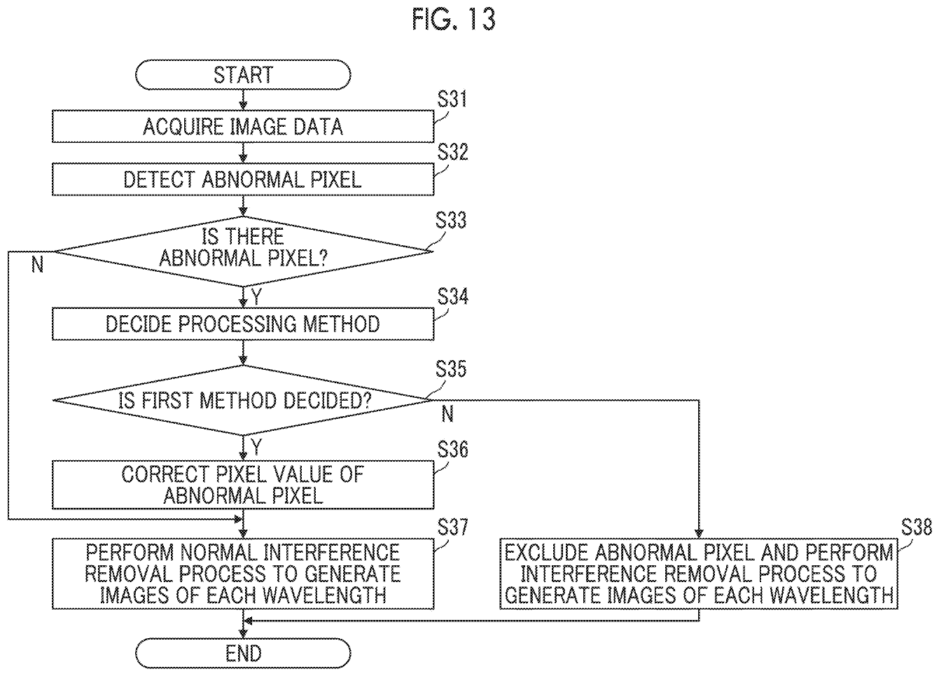

FIG. 13 is a flowchart illustrating a procedure of image data processing by the image data processing device.

First, image data is acquired from the multispectral camera 10 (Step S31). Then, the abnormal pixel is detected in the acquired image data (Step S32). Then, it is determined whether the abnormal pixel is present or absent on the basis of the detection result of the abnormal pixel (Step S33).

In a case in which the abnormal pixel is absent, the normal interference removal process is performed to generate the images of each wavelength (Step S37).

On the other hand, in a case in which the abnormal pixel is present, an image generation processing method is decided on the basis of the cause of the abnormality (Step S34). In a case in which the cause of the abnormality is saturation, the first method is selected as the image generation processing method. As described above, the first method is a method that corrects the pixel value of the abnormal pixel and generates the images of each wavelength. In a case in which the cause of the abnormality is a failure, the second method is selected as the image generation processing method. As described above, the second method is a method that excludes the abnormal pixel and generates the images of each wavelength.

After the image generation processing method is decided, it is determined whether or not the decided processing method is the first method (Step S35).

In a case in which the image generation processing method is the first method, that is, in a case in which the abnormality is caused by saturation, a process of correcting the pixel value of the abnormal pixel is performed (Step S36). Then, as in the case in which the abnormal pixel is absent, the normal interference removal process is performed to generate the images of each wavelength (Step S37).

In a case in which the image generation processing method is the second method (in a case in which the determination in Step S35 is “N”), the abnormal pixel is excluded, and the interference removal process is performed to generate the images of each wavelength (Step S38). Specifically, in the pixel set including the abnormal pixel, the abnormal pixel is excluded, and the interference removal process is performed. The normal interference removal process is performed on the pixel set that does not include the abnormal pixel. In the pixel set including the abnormal pixel, the interference removal matrix is switched according to the position of the abnormal pixel, and the interference removal process is performed.

The above-described process may be performed in units of pixel sets or in units of image data.

As described above, according to the image data processing device of this embodiment, the interference removal processing method is changed depending on whether abnormality is present or absent and the cause of the abnormality. Therefore, it is possible to generate a high-quality image with high efficiency.

### Modification Examples

[Method for Specifying Abnormal Pixel]

Here, another example of the method for specifying an abnormal pixel in a pixel set in a case in which the pixel set including the abnormal pixel is detected will be described.

(1) Method for Specifying Abnormal Pixel Using Peripheral Pixel Sets

Here, a method for specifying the abnormal pixel using peripheral pixel sets in a case in which a pixel set including the abnormal pixel is detected will be described.

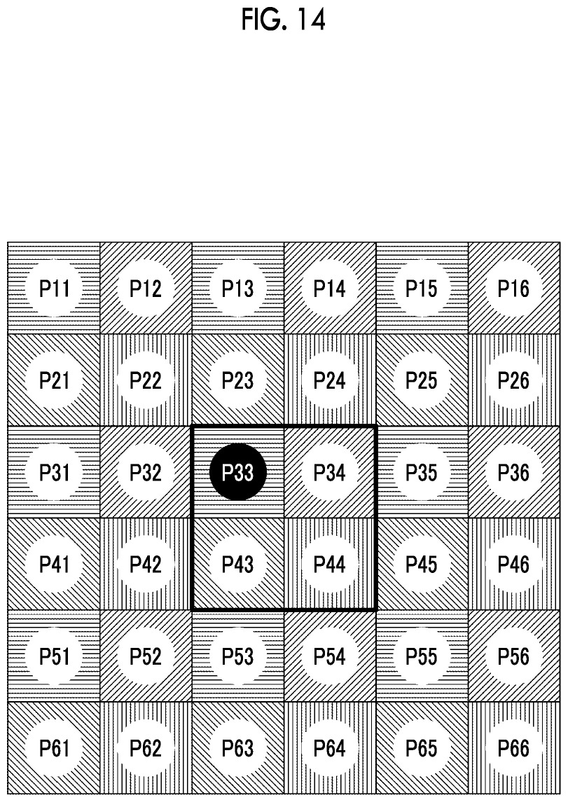

FIG. 14 is a conceptual diagram illustrating the method for specifying the abnormal pixel using the peripheral pixel sets.

FIG. 14 schematically illustrates the arrangement of pixels. Each of the hatched squares indicates a pixel. The numbers in the square are numbers for distinguishing each pixel. In addition, the hatching in the square indicates the orientation of the transmission axis of each pixel (the angle of the transmission axis of the polarizer). For example, the orientation of the transmission axis of a pixel P11 is 0°, the orientation of the transmission axis of a pixel P12 is 45°, the orientation of the transmission axis of a pixel P22 is 90°, and the orientation of the transmission axis of a pixel P21 is 135°.

In FIG. 14, it is assumed that a pixel set (a pixel set surrounded by a frame represented by a thick line) composed of a pixel P33, a pixel P34, a pixel P44, and a pixel P43 is the pixel set to be detected. Further, it is assumed that the pixel P33 is the abnormal pixel.

In a case in which the pixel set including the abnormal pixel is detected, first, the intensity value E is calculated from eight pixel sets around the pixel set.

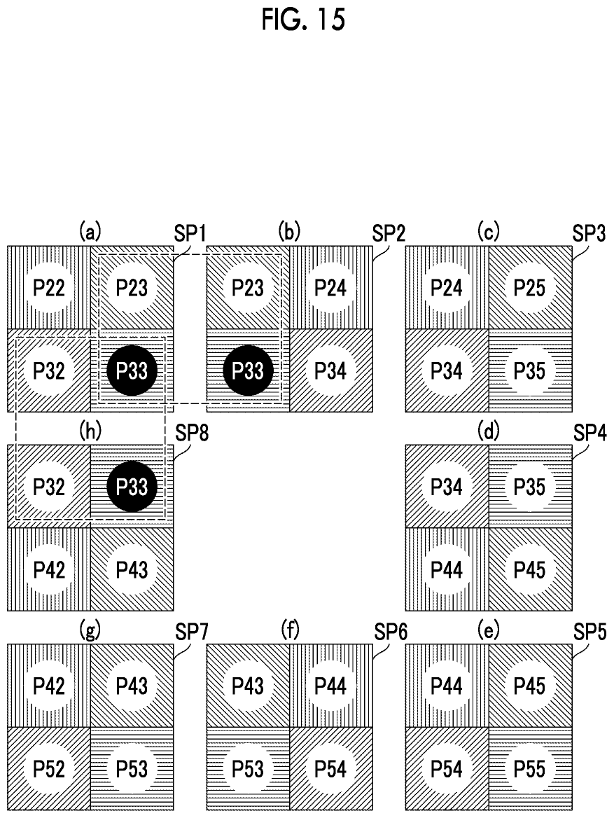

FIG. 15 is a diagram illustrating eight peripheral pixel sets. As illustrated in FIG. 15, the eight peripheral pixel sets are as follows: (a) a pixel set SP1 composed of a pixel P22, a pixel P23, a pixel P33, and a pixel P32; (b) a pixel set SP2 composed of the pixel P23, a pixel P24, a pixel P34, and the pixel P33; (c) a pixel set SP3 composed of the pixel P24, a pixel P25, a pixel P35, and the pixel P34; (d) a pixel set SP4 composed of the pixel P34, the pixel P35, a pixel P45, and a pixel P44; (e) a pixel set SP5 composed of the pixel P44, the pixel P45, a pixel P55, and a pixel P54, (f) a pixel set SP6 composed of the pixel P43, the pixel P44, the pixel P54, and a pixel P53; (g) a pixel set SP7 composed of the pixel P42, the pixel P43, the pixel P53, and a pixel P52; and (h) a pixel set SP8 composed of the pixel P32, the pixel P33, the pixel P43, and the pixel P44. The intensity value E is calculated for each pixel set.

Then, a pixel set in which the intensity value E is equal to or greater than the threshold value Th1 is extracted from the eight peripheral pixel sets. As described above, in the pixel set including the abnormal pixel, the intensity value E is equal to or greater than the threshold value Th1. Therefore, the intensity value E can be calculated to detect the pixel set including the abnormal pixel from the eight peripheral pixel sets. In this example, in the pixel set including the pixel P33, the intensity value E is equal to or greater than the threshold value Th1. Specifically, in the pixel set SP1, the pixel set SP2, and the pixel set SP8, the intensity value E is equal to or greater than the threshold value Th1.

Then, in the extracted pixel sets, an overlapping pixel is extracted. That is, the overlapping pixel between the pixel sets including the abnormal pixel is extracted. In this example, the overlapping pixel among the pixel set SP1, the pixel set SP2, and the pixel set SP8 is extracted. The overlapping pixel among the pixel set SP1, the pixel set SP2, and the pixel set SP8 is only the pixel P33. The extracted pixel (pixel P33) is specified as the abnormal pixel.

The cause of the abnormality is determined from the pixel value of the specified abnormal pixel. For example, in a case in which the pixel value of the specified abnormal pixel is close to 0, it is determined that the abnormality is caused by a failure. In addition, in a case in which the pixel value of the specified abnormal pixel is the saturation value, it is determined that the abnormality is caused by saturation.

As described above, the calculation of the intensity values E of the peripheral pixel sets makes it possible to specify the abnormal pixel from the information of the intensity values E.

In addition, the range of the pixel set to be referred to can be further expanded. For example, 16 peripheral pixel sets may be further added as the range of the pixel set to be referred to. The expansion of the range of the pixel set to be referred to makes it possible to specify the abnormal pixel with higher accuracy.

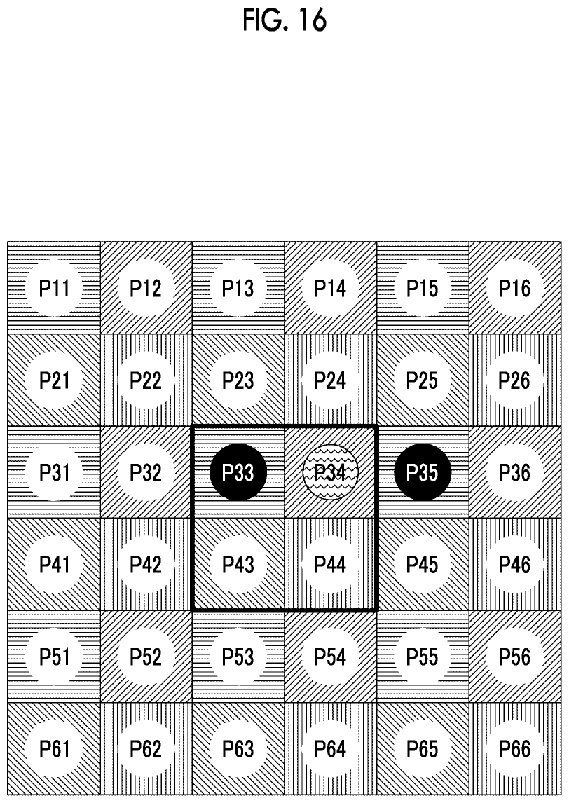

FIG. 16 is a conceptual diagram in a case in which the range of the pixel set to be referred to is expanded and the abnormal pixel is specified.

FIG. 16 illustrates an example of a case in which the abnormal pixel is specified further with reference to 16 peripheral pixel sets.

In FIG. 16, it is assumed that a pixel set (a pixel set surrounded by a frame represented by a thick line) composed of a pixel P33, a pixel P34, a pixel P44, and a pixel P43 is the pixel set to be detected. Further, it is assumed that the pixel P33 is the abnormal pixel.

First, the intensity value E is calculated for eight pixel sets around the pixel set to be detected.

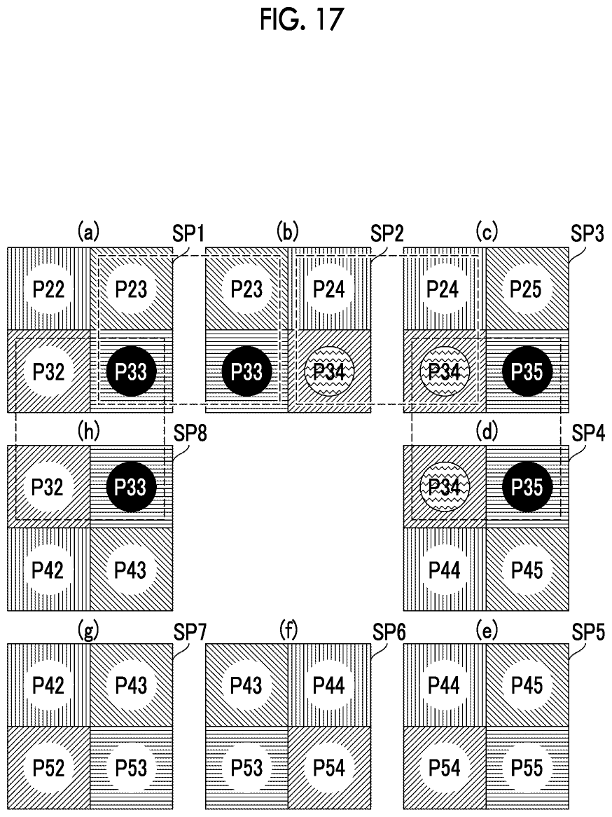

FIG. 17 is a diagram illustrating eight peripheral pixel sets. As illustrated in FIG. 17, the eight peripheral pixel sets are as follows: (a) a pixel set SP1 composed of a pixel P22, a pixel P23, a pixel P33, and a pixel P32; (b) a pixel set SP2 composed of the pixel P23, a pixel P24, a pixel P34, and the pixel P33; (c) a pixel set SP3 composed of the pixel P24, a pixel P25, a pixel P35, and the pixel P34; (d) a pixel set SP4 composed of the pixel P34, the pixel P35, a pixel P45, and a pixel P44; (e) a pixel set SP5 composed of the pixel P44, the pixel P45, a pixel P55, and a pixel P54, (f) a pixel set SP6 composed of the pixel P43, the pixel P44, the pixel P54, and a pixel P53; (g) a pixel set SP7 composed of the pixel P42, the pixel P43, the pixel P53, and a pixel P52; and (h) a pixel set SP8 composed of the pixel P32, the pixel P33, the pixel P43, and the pixel P44. The intensity value E is calculated for each pixel set.

Then, the abnormal pixel is specified on the basis of the calculated intensity values E of the eight peripheral pixel sets. As described above, in this example, the pixel P33 and the pixel P35 are the abnormal pixels. In this case, the pixel P34, which is a normal pixel, is also determined to be the abnormal pixel. Therefore, a process of specifying a truly abnormal pixel is performed further with reference to 16 peripheral pixel sets in a case in which the abnormal pixels are specified at two positions.

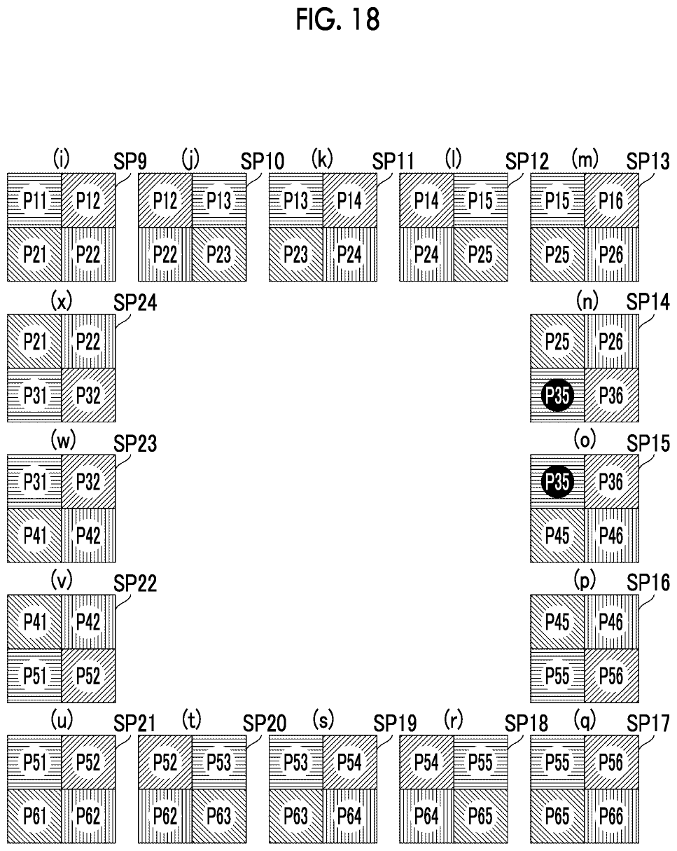

FIG. 18 is a diagram further illustrating 16 peripheral pixel sets.

As illustrated in FIG. 18, the 16 peripheral pixel sets are as follows: (i) a pixel set SP9 composed of a pixel P11, a pixel P12, the pixel P22, and a pixel P21; (j) a pixel set SP10 composed of the pixel P12, a pixel P13, the pixel P23, and the pixel P22; (k) a pixel set SP11 composed of the pixel P13, a pixel P14, the pixel P24 and the pixel P23; (l) a pixel set SP12 composed of the pixel P14, a pixel P15, the pixel P25, and the pixel P24; (m) a pixel set SP13 composed of the pixel P15, a pixel P16, the pixel P26, and the pixel P25; (n) a pixel set SP14 composed of the pixel P25, the pixel P26, a pixel P36, and the pixel P35; (o) a pixel set SP15 composed of the pixel P35, the pixel P36, a pixel P46, and the pixel P45; (p) a pixel set SP16 composed of the pixel P45, the pixel P46, a pixel P56, and the pixel P55; (q) a pixel set SP17 composed of the pixel P55, the pixel P56, a pixel P66, and a pixel P65; (r) a pixel set SP18 composed of the pixel P54, the pixel P55, the pixel P65, and a pixel P64; (s) a pixel set SP19 composed of the pixel P53, the pixel P54, the pixel P64, and a pixel P63; (t) a pixel set SP20 composed of the pixel P52, the pixel P53, the pixel P63, and a pixel P62; (u) a pixel set SP21 composed of a pixel P51, the pixel P52, the pixel P62, and a pixel P61; (v) a pixel set SP22 composed of a pixel P41, the pixel P42, the pixel P52, and the pixel P51; (w) a pixel set SP23 composed of a pixel P31, the pixel P32, the pixel P42, and the pixel P41; and (x) a pixel set SP24 composed of the pixel P21, the pixel P22, the pixel P32, and the pixel P31.

First, the intensity values E of the 16 peripheral pixel sets are calculated. In the case of this example, the intensity values E are calculated for the pixel sets SP9 to SP24. This makes it possible to detect a pixel set including the abnormal pixel in the 16 peripheral pixel sets. In the case of this example, in the pixel sets around the pixel P33, the pixel set including the abnormal pixel is not detected. On the other hand, in the pixel sets around the pixel P35, the pixel set including the abnormal pixel is detected. Therefore, it can be determined that the pixel P33 is the truly abnormal pixel. On the other hand, it is not possible to determine whether or not the pixel P34 is the truly abnormal pixel.

Therefore, then, a process of correcting the value of the pixel P33 determined to be the truly abnormal pixel is performed. After the correction, the intensity value E is calculated again for the pixel set to be detected. In a case in which the calculated intensity value E is less than the threshold value Th1, the pixel set to be detected does not include the abnormal pixel. Therefore, it can be determined that the pixel P34 is not the abnormal pixel.

As described above, the expansion of the range of the pixel set to be referred to makes it possible to detect the abnormal pixel with high accuracy even in a case in which the abnormal pixel is present in the periphery.

Further, it is possible to detect a pixel having an abnormal output (a pixel that outputs a value deviating from the original output) in addition to the failed pixel and the saturated pixel.

It is preferable that the range of the pixel set to be referred to is set according to, for example, the resolution of the lens device and a required resolution.

Here, the resolution of the lens device means the resolution of the lens device used in an imaging situation. Since the resolution of the lens device is the resolution in the imaging situation, for example, the resolution of the lens device changes in a case in which a stop value (F-number) changes. In addition, the resolution of the lens device also changes depending on an object distance.

Further, the required resolution means the resolution of the imaging element that can satisfactorily depict the size of a region of interest of an object captured on the imaging element in a case in which the object is captured. For example, the region of interest is a defect in imaging for detecting defects and is the object in imaging for discriminating the object. For example, a case in which a defect of 100 [mm] is detected is considered. In a case in which the multispectral camera is set at a position where an imaging magnification is 0.01, a defect with a size of 1 [mm] is captured on the imaging element. The number of pixels (pixel size) that can satisfactorily depict the size of 1 [mm] is the required resolution.

It is preferable to expand the range of the pixel set to be referred to in a case in which the resolution of the lens device is low and to narrow the range in a case in which the resolution is high. Similarly, it is preferable to expand the range of the pixel set to be referred to in a case in which the required resolution is low and to narrow the range in a case in which the required resolution is high.

For example, in a case in which the resolution of the lens device is low (in a case in which the resolution of the lens device is equal to or less than a threshold value), the process of specifying the abnormal pixel is performed further with reference to 16 peripheral pixel sets in addition to 8 peripheral pixel sets. On the other hand, in a case in which the resolution of the lens device is high (in a case in which the resolution of the lens device exceeds the threshold value), the process of specifying the abnormal pixel is performed using only eight peripheral pixel sets.

In addition, for example, in a case in which the required resolution is low (in a case in which the required resolution is equal to or less than a threshold value), the process of specifying the abnormal pixel is performed further with reference to 16 peripheral pixel sets in addition to 8 peripheral pixel sets. On the other hand, in a case in which the required resolution is high (in a case in which the required resolution exceeds the threshold value), the process of specifying the abnormal pixel is performed using only eight peripheral pixel sets.

For example, in a case in which an object is imaged and the size of a region of interest of the object captured on the imaging element is “a”, the range of the pixel set to be referred to can be expanded in a range in which the overall size of the pixel set to be referred to is equal to or less than “a”.

The range of the pixel set to be referred to may be set according to the number of abnormal pixels in addition to the resolution of the lens device, the required resolution, and the like. For example, only in a case in which the number of abnormal pixels is large (in a case in which the number of abnormal pixels is equal to or greater than a threshold value), the range of the pixel set to be referred to is expanded, and the process of specifying the abnormal pixel is performed. For example, in a case in which the number of abnormal pixels is large (in a case in which the number of abnormal pixels is equal to or greater than the threshold value), the process of specifying the abnormal pixel is performed further with reference to 16 peripheral pixel sets in addition to 8 peripheral pixel sets. On the other hand, in a case in which the number of abnormal pixels is small (in a case in which the number of abnormal pixels is less than the threshold value), the process of specifying the abnormal pixel is performed using only eight peripheral pixel sets.

(2) Method for Specifying Abnormal Pixel with Reference to Pixel Values of Peripheral Pixels of Same Type

Here, a method for specifying the abnormal pixel with reference to the pixel values of the peripheral pixels of the same type will be described. The pixels of the same type are pixels provided with the same polarizer.

In this method, a pixel having a pixel value that deviates from a value (estimated value) estimated from the pixel values of the peripheral pixels of the same type is estimated as the abnormal pixel.

The estimated value can be calculated using a known method such as a bilinear method or a bicubic method. For example, in the example illustrated in FIG. 14, for the pixel P33, an estimated value is calculated on the basis of the pixel values of the pixel P31 and the pixel P35. Specifically, an average value of the pixel values of the pixel P31 and the pixel P35 is calculated. Similarly, for the pixel P34, an estimated value is calculated on the basis of the pixel values of the pixel P32 and the pixel P36. For the pixel P44, an estimated value is calculated on the basis of the pixel values of the pixel P42 and the pixel P46. For the pixel P43, an estimated value is calculated on the basis of the pixel values of the pixel P41 and the pixel P45.

That is, the estimated value is calculated on the basis of the pixel values of two pixels of the same type which are disposed at positions having a target pixel interposed therebetween. Therefore, for example, for the pixel P33, the estimated value may be calculated on the basis of the pixel values of the pixel P13 and the pixel P53, the pixel values of the pixel P11 and the pixel P55, or the pixel values of the pixel P15 and the pixel P51. The same is applied to other pixels.

The estimated value is calculated for each pixel in the pixel set to be detected, and a pixel having a pixel value that deviates from the estimated value is estimated as the abnormal pixel. Specifically, for each pixel, the difference between the pixel value and the estimated value is calculated, and the calculated difference is compared with a threshold value Th3. The difference is calculated as an absolute value of the difference between the pixel value and the estimated value. A pixel in which the calculated difference is equal to or greater than the threshold value Th3 is estimated as the abnormal pixel. The threshold value Th3 is an example of a third threshold value.

As described above, it is possible to specify the abnormal pixel with reference to the pixel values of the peripheral pixels of the same type.

(3) Other Methods

The specification of the abnormal pixel can be performed by combining a plurality of methods including the method according to the above-described embodiment (the method for specifying the abnormal pixel from the pixel values). For example, it is possible to adopt a method that specifies the abnormal pixel using both the method for specifying the abnormal pixel from the pixel values and the method using the peripheral pixel sets. Alternatively, it is possible to adopt a method that specifies the abnormal pixel using both the method for specifying the abnormal pixel from the pixel values and the method referring to the pixel values of the peripheral pixels of the same type. As described above, the specification of the abnormal pixel by a combination of a plurality of methods makes it possible to detect the abnormal pixel with high accuracy.

[Method for Correcting Pixel Value of Abnormal Pixel]

In the above-described embodiment, in a case in which the abnormal pixel is detected, the pixel value of the abnormal pixel is estimated and corrected using the relationship represented by Equation (1). However, the method for correcting the pixel value of the abnormal pixel is not limited thereto. As in the case in which the abnormality is detected, the pixel value of the abnormal pixel may be estimated and corrected using the pixel values of the peripheral pixels of the same type. For example, in the example illustrated in FIG. 14, in a case in which the pixel P33 is the abnormal pixel, the pixel value of the pixel P33 can be estimated and corrected on the basis of the pixel values of the pixel P31 and the pixel P35. In this case, specifically, the average value of the pixel values of the pixels P31 and the pixel P35 is calculated to estimate and correct the pixel value.

### Other Embodiments and Modification Examples

### Modification Example of Method for Detecting Pixel Set Including Abnormal Pixel

As described above, in a case in which one pixel set SP is composed of four pixels P1 to P4 including polarizers of which the angles of the transmission axes are 0°, 45°, 90°, and 135°, respectively, the relationship of the above-described Equation (1) is established. That is, the relationship of x1+x3=x2+x4 is established. In the above-described embodiment, the intensity value E=(x1+x3)−(x2+x4) is calculated using the relationship of this equation. In a case in which the intensity value E is equal to or greater than the threshold value Th1, it is determined that the target pixel set SP includes the abnormal pixel.

Even in a case in which a combination of four pixels constituting one pixel set SP is different from the combination according to the above-described embodiment, the intensity value E can be calculated by the same method, and it is possible to determine whether or not the abnormal pixel is included. Hereinafter, examples of a case in which one pixel set is composed of four pixels and the orientations of the transmission axes of the pixels (the angles of the transmission axes of the polarizers provided in the pixels) are 0°, 60°, 90°, or 120° and a case in which the orientations are 0°, 45°, 60°, and 120° will be described.

(1) Case in which Orientations of Transmission Axes of Each Pixel are 0°, 60°, 90°, and 120°

In a case in which one pixel set is composed of four pixels and the orientations of the transmission axes of the pixels are 0°, 60°, 90°, and 120°, the relationship of the following equation is established.

I₀−2×I₆₀+3×I₉₀−2×I₁₂₀=0

Here, I₀ is a pixel value of a pixel of which the orientation of the transmission axis is 0°. Further, I₆₀ is a pixel value of a pixel of which the orientation of the transmission axis is 60°. Further, I₉₀ is a pixel value of a pixel of which the orientation of the transmission axis is 90°. Further, I₁₂₀ is a pixel value of a pixel of which the orientation of the transmission axis is 120°.

Therefore, in a case in which the orientations of the transmission axes of the four pixels are 0°, 60°, 90°, and 120°, the intensity value E is calculated by the following equation. In a case in which the intensity value E is equal to or greater than the threshold value Th1, it is determined that the target pixel set includes the abnormal pixel.

E=I₀−2×I₆₀+3×I₉₀−2×I₁₂₀

(2) Case in which Orientations of Transmission Axes of Each Pixel are 0°, 45°, 60°, and 120°

In a case in which one pixel set is composed of four pixels and the orientations of the transmission axes of the pixels are 0°, 45°, 60°, and 120°, respectively, the relationship of the following equation is established.

I₀−3×I₄₅+(√3+1)×I₆₀−(√3−1)×I₁₂₀=0

Here, I₀ is a pixel value of a pixel of which the orientation of the transmission axis is 0°. In addition, I₄₅ is a pixel value of a pixel of which the orientation of the transmission axis is 45°. Further, I₆₀ is a pixel value of a pixel of which the orientation of the transmission axis is 60°. Further, I₁₂₀ is a pixel value of a pixel of which the orientation of the transmission axis is 120°.

Therefore, in a case in which the orientations of the transmission axes of each pixel are 0°, 45°, 60°, or 120°, the intensity value E is calculated by the following equation. In a case in which the intensity value E is equal to or greater than the threshold value Th1, it is determined that the target pixel set includes the abnormal pixel.

E=I₀−3×I₄₅+(√3+1)×I₆₀−(√3−1)×I₁₂₀

As described above, a relational expression of the pixel values of each pixel is calculated on the basis of the orientations of the transmission axes of each pixel, and a calculation expression of the intensity value E is set. The calculated relational expression of the pixel values of each pixel can also be used to correct the pixel value of the abnormal pixel.

### Modification Example of Imaging Element

In the above-described embodiment, an example of a case in which the imaging element is a so-called monochrome imaging element has been described. However, the invention can also be applied to a case in which the imaging element is a color imaging element. In a color polarization imaging element, color filters are disposed in units of pixel sets. That is, color filters of the same color are provided in each pixel in the same pixel set. A known array, such as a Bayer array, is adopted as the array of the color filters.

In a case in which the imaging element is the color imaging element, the process of specifying the abnormal pixel is performed in units of colors. For example, in the method for specifying the abnormal pixel with reference to the pixel values of the peripheral pixels of the same type, the abnormal pixel is specified with reference to the pixel values of the pixels comprising the same polarizer and the same color filter.

### Modification Example of Multispectral Camera

In the multispectral camera, the lens device and the camera body are configured according to the number of wavelengths imaged at the same time. For example, in a case in which the multispectral images of two wavelengths are captured, the lens device is configured to spectrally separate incident light into two wavelengths, polarizes light with each of the spectrally separated wavelengths in a specific direction, and emits the polarized light. In addition, a polarization imaging element comprising polarizers oriented in at least two directions is used as the imaging element of the camera body.

Preferably, the lens device has a configuration in which the filter unit is attachable to and detachable from a lens barrel and is freely exchangeable. This makes it possible to capture images of various wavelengths only by exchanging the filter unit.

In addition, preferably, the filter unit also has a configuration in which the filters (the band-pass filter and the polarized light filter) mounted on each window portion are attachable and detachable or are exchangeable. This makes it possible to freely change the number of wavelengths to be spectrally separated or combinations thereof. Further, in this case, it is not necessary to use all of the window portions. For example, in a case in which the filter frame comprises four window portions and images of three wavelengths are captured, one window portion can be used to shield light.

In addition, the band-pass filter and the polarized light filter mounted on each window portion may be individually or integrally (joined and) mounted on the window portions. In a case in which the filters are integrated, a configuration can be adopted in which an air layer is not included between the filters. In a case in which the filters are integrated, for example, the filters can be joined and integrated by optical contact.

In addition, the shape of each window portion comprised in the filter unit is not particularly limited, and various shapes can be adopted. For example, the window portion may have a fan-like shape that is equally divided in a circumferential direction.

### Modification Example of Image Data Processing Device

In the multispectral camera system according to the above-described embodiment, the multispectral camera and the image data processing device are separately configured. However, the camera body of the multispectral camera may have the functions of the image data processing device.

In addition, the functions implemented by the image data processing device are implemented by various processors. The various processors include, for example, a CPU and/or a graphic processing unit (GPU) as a general-purpose processor executing a program to function as various processing units, a programmable logic device (PLD), such as a field programmable gate array (FPGA), which is a processor whose circuit configuration can be changed after manufacture, and a dedicated electric circuit, such as an application specific integrated circuit (ASIC), which is a processor having a dedicated circuit configuration designed to perform a specific process. The program is synonymous with software.

One processing unit may be configured by one of the various processors or by a combination of two or more processors of the same type or different types. For example, one processing unit may be configured by a combination of a plurality of FPGAs or a combination of a CPU and an FPGA. In addition, a plurality of processing units may be configured by one processor. A first example in which the plurality of processing units are configured by one processor is an aspect in which one processor is configured by a combination of one or more CPUs and software and functions as a plurality of processing units. A representative example of this aspect is a client computer or a server computer. A second example of the configuration is an aspect in which a processor that implements the functions of the entire system including a plurality of processing units using one integrated circuit (IC) chip is used. A representative example of this aspect is a system on-chip (SoC). As described above, various processing units are configured using one or more of the various processors as a hardware structure.

### EXPLANATION OF REFERENCES

1: multispectral camera system
10: multispectral camera
100: lens device
110A: lens group
110B: lens group
120: filter unit
122: filter frame
122A: window portion (first window portion)
122B: window portion (second window portion)
122C: window portion (third window portion)
123A: band-pass filter (first band-pass filter)
123B: band-pass filter (second band-pass filter)
123C: band-pass filter (third band-pass filter)
124A: polarized light filter (first polarized light filter)
124B: polarized light filter (second polarized light filter)
124C: polarized light filter (third polarized light filter)
200: camera body
210: imaging element
300: image data processing device
311: CPU
312: ROM
313: RAM
314: auxiliary storage device
315: input device
316: output device
317: input/output interface
320: image data acquisition unit
321: abnormal pixel detection unit
322: pixel value correction unit
323: image generation unit
324: output control unit
325: recording control unit
326: processing method decision unit
P1: pixel (first pixel)
P2: pixel (second pixel)
P3: pixel (third pixel)
P4: pixel (fourth pixel)
P11 to P16: pixel
P21 to P26: pixel
P31 to P36: pixel
P41 to P46: pixel
P51 to P56: pixel
P61 to P66: pixel
SP: pixel set
SP1 to SP24: pixel set
Z: optical axis
S1 to S3: procedure of abnormal pixel detection processing
S11 to S13: procedure of image data processing
S21_1 to S21_6: procedure of process of detecting and correcting abnormal pixel
S31 to S37: procedure of image data processing

What is claimed is:

1. An image data processing device that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers, the image data processing device comprising:
a processor configured to perform:
a process of acquiring the image data;
a process of detecting a pixel whose pixel value is out of a predetermined range as an abnormal pixel from the acquired image data;
a process of correcting a pixel value of the abnormal pixel on the basis of pixel values of peripheral pixels having polarizers whose types are different from a type of a polarizer of the abnormal pixel in a case in which the abnormal pixel is detected; and
a process of generating images of the spectrally separated wavelengths from the image data in which the pixel value of the abnormal pixel has been corrected in a case in which the abnormal pixel is detected.

2. The image data processing device according to claim 1,
wherein, in the process of correcting the pixel value of the abnormal pixel, the pixel value of the abnormal pixel is corrected based on pixel values of other pixels in a pixel set in which the abnormal pixel has been detected.

3. The image data processing device according to claim 1,
wherein, in the process of correcting the pixel value of the abnormal pixel, the pixel value of the abnormal pixel is corrected based on a relational expression of pixel values established between pixels constituting the pixel sets.

4. The image data processing device according to claim 3,
wherein the relational expression is obtained based on orientations of the transmission axes of respective pixels constituting the pixel sets.

5. The image data processing device according to claim 1,
wherein the processor performs a process of correcting the pixel value of the abnormal pixel on the basis of the pixel values of the peripheral pixels in a case in which the pixel value is out of the predetermined range due to saturation.

6. The image data processing device according to claim 1,
wherein the processor performs a process of generating the images of the spectrally separated wavelengths from the image data excluding the abnormal pixel, without correcting the pixel value of the abnormal pixel, in a case in which the pixel value is out of the predetermined range due to a failure.

7. The image data processing device according to claim 1,
wherein the process of detecting the abnormal pixel includes:
a process of detecting a pixel set including the abnormal pixel; and
a process of specifying the abnormal pixel from the detected pixel set.

8. An image data processing device that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers, the image data processing device comprising:
a processor configured to perform:
a process of acquiring the image data;
a process of detecting a pixel whose pixel value is out of a predetermined range as an abnormal pixel from the acquired image data;
a process of correcting a pixel value of the abnormal pixel on the basis of pixel values of peripheral pixels in a case in which the abnormal pixel is detected; and
a process of generating images of the spectrally separated wavelengths from the image data in which the pixel value of the abnormal pixel has been corrected in a case in which the abnormal pixel is detected,
wherein the process of detecting the abnormal pixel includes:
a process of detecting a pixel set including the abnormal pixel; and
a process of specifying the abnormal pixel from the detected pixel set.

9. The image data processing device according to claim 7,
wherein, in the process of detecting the pixel set including the abnormal pixel, the pixel set including the abnormal pixel is detected on the basis of pixel values of pixels constituting the pixel set.

10. The image data processing device according to claim 9,
wherein, in the process of detecting the pixel set including the abnormal pixel,
a sum of the pixel values of the pixels constituting the pixel set or a sum of values obtained by multiplying the pixel values of the pixels constituting the pixel set by a specific coefficient is calculated, and a pixel set in which the calculated sum is equal to or greater than a first threshold value is detected as the pixel set including the abnormal pixel.

11. The image data processing device according to claim 9,
wherein, in the process of specifying the abnormal pixel, a pixel whose pixel value is equal to or less than a second threshold value and/or a pixel whose pixel value is a saturation value is extracted from the pixel set including the abnormal pixel, and the abnormal pixel is specified.

12. The image data processing device according to claim 9,
wherein, in the process of specifying the abnormal pixel, the abnormal pixel is specified on the basis of pixel values of pixels around the pixel set including the abnormal pixel.

13. The image data processing device according to claim 12,
wherein the process of specifying the abnormal pixel includes:
a process of detecting the pixel set including the abnormal pixel from pixel sets around the pixel set including the abnormal pixel; and
a process of specifying the abnormal pixel from the pixel set including the abnormal pixel on the basis of a detection result of the pixel set including the abnormal pixel.

14. The image data processing device according to claim 13,
wherein a range in which the pixel set including the abnormal pixel is detected is switched according to a resolution of the optical system.

15. The image data processing device according to claim 12,
wherein the process of specifying the abnormal pixel includes:
a process of estimating a pixel value of a pixel from the pixel values of the peripheral pixels; and
a process of specifying a pixel in which a difference from the estimated pixel value is equal to or greater than a third threshold value as the abnormal pixel.

16. The image data processing device according to claim 15,
wherein, in the process of estimating the pixel value of the pixel from the pixel values of the peripheral pixels, the pixel value is estimated from pixel values of peripheral pixels including polarizers of the same type.

17. An image data processing method that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers, the image data processing method comprising:
a process of acquiring the image data;
a process of detecting a pixel whose pixel value is out of a predetermined range as an abnormal pixel from the acquired image data;
a process of correcting a pixel value of the abnormal pixel on the basis of pixel values of peripheral pixels having polarizers whose types are different from a type of a polarizer of the abnormal pixel in a case in which the abnormal pixel is detected; and
a process of generating images of the spectrally separated wavelengths from the image data in which the pixel value of the abnormal pixel has been corrected in a case in which the abnormal pixel is detected.

18. An image data processing method that processes image data captured by an imaging device including an optical system which spectrally separates incident light into a plurality of wavelengths, polarizes light with the spectrally separated wavelengths in a specific direction, and emits the polarized light and an imaging element including a plurality of pixel sets each of which includes different types of polarizers, the image data processing method comprising:
a process of acquiring the image data;
a process of detecting a pixel whose pixel value is out of a predetermined range as an abnormal pixel from the acquired image data;
a process of correcting a pixel value of the abnormal pixel on the basis of pixel values of peripheral pixels in a case in which the abnormal pixel is detected; and
a process of generating images of the spectrally separated wavelengths from the image data in which the pixel value of the abnormal pixel has been corrected in a case in which the abnormal pixel is detected,
wherein the process of detecting the abnormal pixel includes:
a process of detecting a pixel set including the abnormal pixel; and
a process of specifying the abnormal pixel from the detected pixel set.

19. A non-transitory, computer-readable tangible recording medium that records thereon a program for causing, when read by a computer, the computer to execute the image data processing method according to claim 17.

20. A non-transitory, computer-readable tangible recording medium that records thereon a program for causing, when read by a computer, the computer to execute the image data processing method according to claim 18.

21. An imaging system comprising:
an imaging device that includes an optical system which spectrally separates incident light into a plurality of wavelengths, polarizes light with the spectrally separated wavelengths in a specific direction, and emits the polarized light and an imaging element including a plurality of pixel sets each of which includes different types of polarizers; and
the image data processing device according to claim 1 that processes image data captured by the imaging device.

22. An imaging system comprising:
an imaging device that includes an optical system which spectrally separates incident light into a plurality of wavelengths, polarizes light with the spectrally separated wavelengths in a specific direction, and emits the polarized light and an imaging element including a plurality of pixel sets each of which includes different types of polarizers; and
the image data processing device according to claim 8 that processes image data captured by the imaging device.
